(19) United States
(12) Patent Application Publication
(10) Pub. No.: US 2014/0310329 A1
(43) Pub. Date: Oct. 16, 2014

(54) METHOD AND SYSTEM OF ASSIGNING TOPICS TO ANSWERERS

(71) Applicant: ChaCha Search, Inc, Carmel, IN (US)

(72) Inventors: Scott A. Jones, Carmel, IN (US); Jeffrey Jockisch, Westfield, IN (US)

(73) Assignee: ChaCha Search, Inc, Carmel, IN (US)

(21) Appl. No.: 14/252,981

(22) Filed: Apr. 15, 2014

Related U.S. Application Data
(60) Provisional application No. 61/811,911, filed on Apr. 15, 2013.

(51) Int. Cl. H04L 29/08

(52) U.S. Cl. CPC H04L 67/10
USPC 709/201

(57) ABSTRACT

A system and method for ranking topics for presentation to a responder is based on a corpus, requests and responder actions is described. A topic list is ranked based on correlation of topics, frequency of usage, registration frequency, response type and frequency. Topics are presented explicitly and/or implicitly to a responder based on a ranking of topic which is adjusted for the responder.

### BACKGROUND

1. Field of the Invention

The present invention is related to distribution of requests to human assistants.

2. Description of the Related Art

In a system wherein users may submit questions for responses it is important that queries be directed to interested parties. For example, if a user requests information regarding California the request should be directed to a person who is knowledgeable about California and is interested in responding to questions about California.

Several solutions have been implemented for this problem with varying degrees of success. Peer-to-peer systems such as Answers.com, Yahoo Answers, and Aardvark have been tried. In the case of answers.com and Yahoo Answers, a user may search for questions associated with a topic and then respond to the question. Similarly, if a user submits a question questions with matching keywords may be presented to a user for a potential response. This approach has met with limited success. Response times may be long and there is limited motivation to respond to a request as a user has not indicated an affirmative interest in a topic. A pull type system may not allow a user to be presented with questions on a broad number of interesting topics.

In the case of Aardvark queries are passed to users based on keywords for which the user has registered. In order to improve motivation of users to respond, queries are passed to a network of ‘friends’ who have been identified by a user. If no answer is received from immediate friends, the question is routed to ‘friends of friends’ (i.e., users recommended by the ‘friends’). This ‘friend of friend of friend’ is extended until a number of answerers have been notified, a number of answers are received, or some other suitable termination condition is met. This solution tends to be weakened because as the number of links between an answerer and a requester increases the motivation to respond decreases.

Aside from the motivation to answer on the part of the answerer there is the issue of response time. Users accustomed to search engines such as Bing or Google expect immediate results, even if some additional effort is required to find the precise information requested. If a suitable answerer is not found quickly, the user experience becomes degraded. One solution to this problem is to provide a pool of human assistants who are willing to answer questions regarding a variety of topics and can provide a rapid response. The ChaCha® question and answer service has been well accepted based on this strategy. Such a system may improve user experience, but does not address the underlying need to find an available peer answerer who responds timely.

Because of these and other problems a method and system of assigning keywords to answerers would be greatly appreciated.

### SUMMARY

A user may be registered by a system for distribution of queries. A user may register for topics using tags applied to requests. For example, if a user is browsing questions, the user may elect to select a tag associated with a question, which may cause the user to be registered for the topic. A user may designate a topic as a ‘favorite’ which may cause a query associated with the topic to be more likely to be directed to the user than a topic for which the user has registered. A user may select a topic which is a favorite of another user. For example, if a user is following a Twitter account and the account has designated a topic as a favorite, a user may be provided with an indication to that effect and may favorite and/or register for the topic.

A user may be actively recruited to register for a topic. Queries and answers submitted by a user may be analyzed to determine tags or topics which may be of interest to a user. If a criterion is met a notification may be sent to a user inviting a user to register for the topic or tag. A topic or tag may be determined based on factors such as names of things, such as persons, places, etc., or “named entities”. If a user elects to favorite a topic a more general topic may be suggested to the user. User notifications may be aggregated and/or delivered on a periodic basis. For example, if a user has met a criterion for an invitation to register for a topic, the user may be notified for that topic and any other topics each Friday at 5:00 PM. If a user has been previously notified to register for a topic, a recurrence of a notification trigger may cause the user to be notified again. If a user has been repeatedly notified of a topic, a notification frequency may be reduced or eliminated. A list of suggested topics may be provided to a user. The suggested topics may be provided in a ranked order. Ranking of suggested topics may depend on factors such as how frequently a user has submitted requests and/or answered requests associated with a topic, how recently a topic has been suggested to a user, whether a notification has been delivered to a user, a number of users registered for a topic, a number of questions submitted associated with a topic, individually and/or in combination with other criteria.

A user may be provided with “filtered” views of questions. A user may be provided with tabs or other controls which allow a user to view queries associated with favorites. A query may be directed to a user responsive to registration of the user for a topic. A query directed to a user responsive to a registration or favorite may be a request for which an answer is already available.

A user may be able to block a topic. A user may be provided with suggested blocked topics based on questions which have been presented to the user which the user has declined to answer and/or answers a user has declined to view. If a user declines a number of requests associated with a favorite topic, or registered topic, suggestions for blocked topics may be provided to the user based on content of the requests. For example, if a user has registered for the topic ‘dogs’, but has declined questions indicating ‘Doberman’ a user might be offered the option to block the topic ‘Doberman’. As with suggested favorites or answering topics, a user may be presented with recommended blocked topics in an order based on ranking.

A user may be provided with a search facility for selecting topics. A search facility may search a corpus of nouns and/or noun phrases which are available as topics. Suggested topics may make use of cross-relationships. For example, if a user inputs ‘Persian’ the system may require the user to specify ‘Persian (person)’ or ‘Persian (cat)’. Likewise, if a user selects ‘Persian (person)’ the topic ‘Iranian’ might be suggested as an equivalent favorite. A search facility may provide suggestions in an order based on ranking of the suggestions. For example, if a user input matches an element of a corpus when a letter is transposed, substituted, deleted, etc. that element of the corpus might be ranked higher. Ranking might be based on frequency of occurrence of an element of a corpus. For example, if an equivalent correction would cause a user input to match two elements of a corpus, the element which occurs most frequently in user requests, which is most registered or favorite, which is blocked least, etc. might be ranked higher.

Users may be permitted to add topics to a corpus of topics. If a search facility does not provide a match to a topic desired by a user, the user may be provided with a facility for requesting that the topic be added to a corpus of topics. A topic suggested by a user may be subject to review. A review may be based on criteria such as overlap with existing topics, breadth or specificity of a topic, a number of users requesting to add a topic or similar topic, a number of requests indicating the topic, whether the topic has been blocked, whether a user has answered questions which would be associated with a topic, etc. A review may be based on an assessment by a system administrator, voting by users, voting by a selected group of users, presentation of the topic to users, a number of users who register for the topic during a time period, etc.

A user may be associated with a related topic based on a type associated with a request. If a request is seeking objective information and a responder provides and answer a suggested topic which is closely related may be offered as a suggested topic. For example, if a user responds to a request regarding a member of a sports team, the name of the team, and/or the names of other members of that team might be offered as suggested topics while the names of other teams might not be suggested topics. If a request is determined to be seeking subjective information or opinion, a more general topic might be suggested to a responder if an answer is provided. For example, if an answerer responded to a request seeking subjective information about a sports team, a name of another team, a name of the league, or the name of other sports teams in a nearby geographic location might be offered as suggested topics to the user when receiving subjective requests. Similar relationships might be applied to structured data such as movies, music, politics, industry, science, entertainment, technology, etc.

Topics or keywords may be assigned based on a type associated with a request. If a query is seeking subjective information, a responder may be associated with subjective requests for the topic, but not associated with requests seeking objective information regarding that topic. For example, a person might be selected to respond to requests seeking opinions about “NCAA Basketball”, but might not be willing to respond to factual questions regarding “NCAA Basketball”.

Additional aspects and/or advantages will be set forth in part in the description which follows and, in part, will be apparent from the description or may be learned by practice of the invention. These together with other aspects and advantages, which will be subsequently apparent, reside in the details of construction and operation as more fully hereinafter described, reference being had to the accompanying drawings forming a part hereof, wherein like numerals refer to like parts throughout.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment.

FIG. 2 illustrates a database for requests.

FIG. 3 illustrates a database for users.

FIG. 4 illustrates a database for responders.

FIG. 5 illustrates a database for resources.

FIG. 6 is a flowchart of providing an answer.

FIG. 7 is a flowchart of ranking topics.

FIG. 8 is a flowchart of suggesting topics.

FIG. 9 is a Graphical User Interface (GUI) for submitting a query.

FIG. 10 is a GUI for selecting a topic.

FIG. 11 is a GUI for selecting a query.

FIG. 12 is a GUI for responding to a query.

### DETAILED DESCRIPTION OF THE PREFERRED EMBODIMENTS

Reference will now be made in detail to the present embodiments discussed herein. Examples are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein, words importing the singular shall include the plural and vice versa unless specifically counter indicated.

A system is provided which includes a user system for submitting a query and receiving a response, a search server receiving the query, a database storing information of queries, search results, searchers, responders, users, resources and other information, a responder system receiving a query and providing a response, and a resource system providing answers and/or other media responsive to a request or query or search request or question.

A system is implemented to allow a user to submit a query and receive a response. A response may include any type of media such as text, URL's, audio, video, etc. A response may be produced automatically and/or using the assistance of a person. A query may be submitted using any suitable device and/or communication service such as SMS, MMS, voice, Instant Messaging, VoIP, internet packet communication, email, etc.

Processing of a query may be divided into various layers. A determination regarding whether a query is a request for objective or factual information or is a request for subjective or opinion information may be made. A query may be determined to be factual in various ways. Automated analysis may be used to determine if a request is seeking factual information. Content of a request may be used to determine whether the query is factual. A user may indicate whether a query is factual. A user may be provided with a control which indicates whether a query is factual. A query may be determined to be factual based on actions by a responder or other person to whom a query is presented.

A layer of processing may consist of automated processing of a query. Automated processing of a query may include comparison of a query to a database, analysis of a query using semantic techniques, pattern matching, etc. which may be used to determine a response to the query. Results of automated processing such as categorization, spelling correction, named entity extraction, location association, etc. may be stored for later use. Automated processing of a query which is determined to be factual may be different from automated processing of a query which is determined to be subjective. For example, a match to a subjective query may be less precise than a match to an objective query. Different resources may be used to determine a response to a subjective query than a factual query.

A second layer of processing of a query may include a human assistant who analyzes the query or “expediter”. An expediter uses the human ability to recognize context in order to determine a response to a query. An expediter may be provided with relevant context of a query, and offered various options for responding to the query. In its simplest form, an expediter might be presented with a question and two or more options for responding to the question. An expediter may be provided with a rich toolset which provides a greater depth and breadth of responses which may be interactive. In at least one embodiment, an expediter may be provided with responses from a predetermined set of resources. An expediter may be used to determine whether a query is subjective or objective. If a query is determined to be subjective an expediter may not be presented with the query.

A third layer of processing of a query may include a human assistant who responds to the query or “searcher”. A searcher or responder or answerer may receive a query, an interpreted query, information of a source of the query, and be provided with resources for performing a search responsive to a query. A searcher may formulate a response based on an interpreted query, and submit the response for delivery to a user responsive to the query. In at least one embodiment, a searcher may receive information of resources which may be used to provide a response, and/or resources which are excluded from providing a response. Selection of a responder for a subjective query may be different than selection of a responder for an objective query. A more general matching may be applied for selection of a responder for a subjective query. An objective query may be directed to a responder based on a type and level of knowledge required to respond to the query.

A responder or answerer may be provided with alternative responses to a request. An answerer may be presented with resources and/or snippets extracted from resources based on content of a request. An answerer may be presented with materials from a database of previous questions. An answerer may be allowed to indicate a question is too difficult, off topic, or subjective. A question may be indicated as objective or subjective to an answerer. An answerer may be able to sort objective and subjective questions based on various criteria such as keywords, temporal data, difficulty, etc. An answerer or responder may be selected to perform roles such as expediter, vetter, searcher, generalist, specialist, etc.

A resource may be characterized according to various parameters. A resource may be evaluated based on a number of responses obtained from and/or using the resource. A resource may be evaluated based on a number of times that a response obtained from the resource is reused. A resource may be evaluated based on an affiliate relationship between a provider of the resource and a provider of search services. A resource may be ranked or evaluated based on a type of response which is to be obtained from the resource. A resource may be ranked based on a category, a topic, a keyword, a level of information provided, a type of information such as objective and/or subjective, etc.

Responders may be associated with topics in order to assist in assigning a request to a responder. Topics may be determined based on a corpus of requests, responses, documents, etc. Topics may be restricted to a predetermined number or type of word and/or phrase. A responder may elect to be associated with a topic as a “favorite” or preferred topic, as an accepted topic, and or as a provisional association based on topics associated with queries submitted by a responder and/or answered by a responder. A responder may elect to block a topic.

A rating of a responder for a request may be determined based on various criteria. A number of responders associated with a topic may influence a rating of a responder for a topic. A number of queries submitted regarding a topic may influence a rating or probability that a responder will receive a notification of a request associated with a topic. A time interval between an activity of a responder and receipt of a request may affect a probability or ranking of a responder for a topic and/or a request. Topics assigned to a responder may affect a ranking of a responder for a topic. For example, if a responder is associated with two topics, a ranking for a more frequently submitted topic may be higher than a ranking for a less frequently submitted topic when the responder is more probable to respond to the less frequently submitted topic. A ranking of a responder may be based on a difficulty rating associated with a topic. For example if a difficult query is associated with a topic, a probability that a responder will answer a difficult query may affect a ranking of the responder for the topic.

A group of responders may be notified of a request. For example, a number of highest ranking responders for a topic associated with a query may be notified of the query. A number of responders notified may be determined based on a topic of a request. For example if responders respond to queries associated with a topic more often, a lower number of responders may be notified. Similarly a type of information sought may affect a number of responders notified. For example, if a request is seeking factual information, a number of responders notified may be increased.

A time interval between an action of a responder and a notification may affect whether a responder will be notified of a request. If a responder has submitted a request, a ranking of a responder to receive a notification of a request associated with a topic indicated by the request may be increased. If a responder has been notified of a request a time interval may be required to elapse before another notification is sent to the responder. If a responder does not respond to a notification within a predetermined time interval, a time interval between a most recent notification and a subsequent notification may be increased in a linear, logarithmic, polynomial, exponential, etc. progression.

As used herein, a “request” means a request for information, products, and/or services. A request or search request or query or question may include various types of media, and may be provided by any user system which may establish communication with a server and/or other devices associated with a search service. A request may be referred to as a “search request”, “search query”, or “query”.

A “user” is a person who submits a request and may receive any type of information responsive to a request. A user may be any person or entity. A “guide” is a person who assists in processing a request. A guide may be referred to as a “provider”, “searcher”, “human searcher”, “responder”, “answerer”, “expediter”, “transcriber”, “specialist” or “generalist”. Guides may be assigned various roles. A guide may be a user. A guide who transcribes a user request from one form to another may be referred to as a transcriber. A guide who reviews a query, determines a most likely response, and may modify a query may be referred to as an expediter or “ambassador”. A guide who performs a search for queries associated with a specific category may be referred to as a specialist. A guide who performs a search for queries regardless of category may be referred to as a generalist. Any guide may perform any role.

An “advertiser” is any person and/or entity which may provide promotional information or “advertisements” to be delivered to a user. An advertisement may take various forms and/or may include media of any sort which can be delivered to a user device. A “result”, “response”, “answer”, or “search result” is any information which has been determined to be a response to a request. A result may include an advertisement. A result may be any information which is provided as a response to a request. A “resource” or “search resource” may be any source of information which may provide a search result and/or other information. A resource may include a search engine, a web server, a software application, an API, printed media, an RSS feed, streaming media, a web page, a database, etc. A “profile” may be any information associated with a person such as demographic data, geographic data, personality data, affiliations, etc. A result may be an “organic” result which is produced by a search which has no intentional bias applied. A result may be a “sponsored” result which is provided and/or approved by a provider with a commercial interest in the response and/or providing the response to a user based on a request for information associated with the sponsored answer or sponsored result.

As used herein, a “topic” may be any word, phrase or other form of metadata which can be associated with a request based on the request. A topic may include a keyword, category, named entity, classification, a location, a source, etc. A topic may be assigned to a request or query automatically and/or using the assistance of a person such as a guide, user, or responder.

Assignment of topics and ranking of topics may assist in optimizing usage of system elements such as responders, guides, etc. A set of topics may be determined based on a corpus of content, media, etc. Topics may be rated and/or ranked for assignment to responders. A ranking of a topic may be determined based on factors such as frequency of association of a topic with queries, a number of responders associated with a topic, correlation of a topic to other topics, temporal usage of a topic, etc. Topics may be ranked for presentation to a responder. If a user has registered to accept queries regarding a topic, but declines queries associated with the topic, a ranking of the topic for a responder may be adjusted.

A ranking of a topic for a responder may be determined based on factors such as topics currently associated with a responder, statistics of responses to queries associated with topics by the responder, a profile of a responder, a number and response frequency associated with other responders, a frequency of queries associated with a topic, etc.

The terms voice and speech are used interchangeably herein. A user, a guide and/or a search system may establish a communication session using a voice service, a messaging service such as Short Messaging Service (SMS), Enhanced Messaging Service (EMS), Multi-media Messaging Service (MMS), Instant Messaging (IM), email, an internet portal or web page, an application, regular mail and/or any other suitable type of communication. A connection or communication session may be established using any device which is capable of utilizing a communication service. For example, a wireless device such as a cell phone, PDA, smart phone, etc., might be used to establish a communication session using voice, SMS, IM, email and/or internet protocols. A desktop, laptop or server system might be used to establish a communication session using IM, email, SMS, MMS, etc. A landline phone, a specialized communication terminal, and/or any other communication device might be used to establish a communication session.

Communication between a user, a guide, a resource and/or a search system may include conversion of text to speech and speech to text. Any type of media which can be sent and/or received using a communication system may be part of a communication session. A communication session may be conducted using any or all communication services associated with a user, a guide, a resource, and/or a search system. Any communication session may include communication via multiple services and/or devices. For example, a request may be submitted as a voice query, which might indicate an image located on a resource accessible to a user. A voice query might be converted to a text message, the image might be processed in order to associate a tag and/or other images with the image, and a response might be provided as a spoken reply to a mobile phone associated with a user, and a video presentation which is accessible via a high-speed connection that might be delivered to a browser functionality of a different user device.

An advertisement may be transmitted, including during any or all communication sessions. A guide, a user, a search result, a resource, a responder, an advertiser and/or a request may be rated. Rating information may be obtained from a user, a guide, an advertiser and/or an administrator of a search system. Rating information may be used to select a user, a guide, a request, a result, a responder, an advertiser, and/or any item based on information associated with an item indicated in a database. A search service may be compensated by advertising revenue. Advertising and/or content may be delivered to a user and/or a guide using any communication service associated with a user and/or a guide. An advertiser may request and obtain information regarding usage, users, demographics, affiliations, etc. associated with queries, keywords, categories, resources etc. and may submit sponsored answers and associate sponsored answers with queries based on information provided.

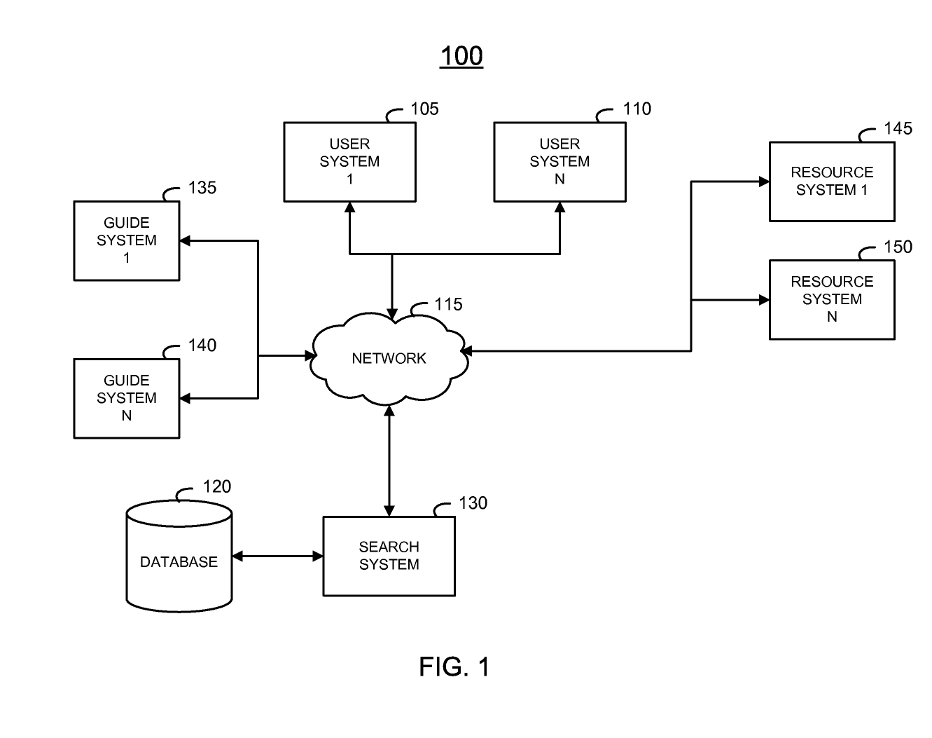

As illustrated in FIG. 1, system 100 includes user systems 105, 110, a network 115 such as the Internet, a search system 130, a database 120, which may comprise various records, guide systems 135, 140, and resource systems 145, 150.

While only a few systems associated with a user, a resource, and a guide or responder are depicted in FIG. 1 it is within the scope of the disclosure for multiple systems for a user, resource, responder and guide to be utilized. In particular it is envisioned that many user, resource and guide systems may be implemented. The search system 130 may be composed of many components as described further herein.

Any user system (e.g. the user system 105) can be used, to submit a request to the search system 130 and/or receive a result and/or other information. Any user system may receive and/or provide a response, and/or may provide compensation to the search system 130.

The network 115 may be a global public network of networks (i.e., the Internet) and/or may consist in whole or in part of one or more private networks and communicatively couples the user systems 105, 110, the guide systems 135, 140, and the resource systems 145, 150 with the other components of the system such as the search system 130, and the database 120. The network 115 may include one or more wireless networks which may enable wireless communication between the various elements of the system 100. For example, the search system 130 may receive messages which may be routed via a wireless network controlled by a wireless service to the user systems 105, 110. A wireless service may receive messages from the guide systems 135, 140 via a wireless network which is a part of the network 115, and provide the messages to the search system 130 via an internet connection which is part of the network 115. Similarly a voice communication via wired and/or wireless communication might be established between any elements of the system 100.

The search system 130 allows interaction to occur among the user systems 105, 110, the guide systems 135, 140, and the resource systems 145, 150. For example, a request can be transmitted from the user system 105 to the search system 130, which may provide information obtained from the database 120, which may include an advertisement to the user system 105. Similarly, a search result from an answerer operating the guide system 135 and/or the resource system 145 might be routed to the search system 130, which might process the search result, formulate a response and provide a message to the user system 105. Any type of communication between users, resources and/or guides may be mediated and/or facilitated by the search system 130, and/or other elements of the system 100.

The search system 130 is communicatively coupled with the database 120. As will be described herein in further detail below, the database 120 includes data that is processed in association with operation of the embodiments. Although FIG. 1 illustrates the database 120 as a separate component of the system, the database 120 may be integrated with the search system 130. Further, the records maintained in the database 120 may be stored in any typical manner, including in a Network Attached Storage (NAS), a Storage Area Network (SAN), RAID, etc., using any typical or proprietary database software such as DB2®, Informix®, Microsoft® SQLServer™, MySQL®, Oracle®, etc., and may also be a distributed database on more than one server. Elements of the database 120 may reside in any suitable elements of the system 100. Any or all elements of the system 100 may include any or the entirety of the database 120.

The user systems 105, 110, the guide systems 135, 140, the resource systems 145, 150 and the search system 130 may include equipment, software, systems and personnel required to send and/or receive messages between a user system 105, 110, the guide systems 135, 140, the resource systems 145, 150 and/or the search system 130 using the network 115. The database 120 includes information which may allow the search system 130 to establish communication between any or all of the elements of the system 100.

A user system, a guide system, and/or a search system may be a desktop, portable, or tablet PC or Mac®, a mobile phone, a smart phone, a PDA, a server system, a wearable computing device, a landline phone, a specialized communication terminal, a terminal connected to a mainframe, or any other communication hardware and/or system. The search system 130 may include one or more servers, computers, etc. For example, servers such as the PowerEdge® 2900 by Dell, or the BladeCenterJS22 by IBM, or equivalent systems might be used to implement elements of the search system 130. The search system 130 may utilize an operating system (OS) such as Microsoft Windows XP, or Linux, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, guide systems, resource systems and/or to implement the search system 130.

A user may be identified by the search system 130. When a user system, such as the user system 105, establishes a communication session with the search system 130, an identifier of a user system is determined. An identifier of a user system may be associated with other information regarding a user. A user system may be identified using an email address, a telephone number, an IM credential, a username, and/or any other identifier which may be used to associate information with a user. Multiple identifiers of a user may be associated with each other. Using information of communication services associated with a user, a communication session may be established between a user system such as the user system 105 and a resource system, a guide system, a sponsor system and/or the search system 130. Information such as a keyword, a category, a user profile, a request, a result, etc., may be associated with a user. A user may be required to provide profile information to the search system 130. A user may elect to receive requests from the search system 130 (i.e., a user may elect to act as a responder). Parameters and/or attributes may be associated with a user and/or a resource as will be further described herein below. Information of a user may be stored in the database 120.

A guide or answerer may be required to register with the search system 130. As part of a registration process, at least one communication method is associated with a guide. In at least one embodiment, a guide may register with the search system 130 and establish a username and password which are associated with the guide. A guide may login to the search system 130 using a web browser functionality of the guide system 135 in order to communicate with the search system 130. Multiple communication services may be associated with a guide and may allow a communication session to be established between a guide system such as the guide system 135 and a user system, a resource system, a sponsor system, and/or the search system 130. Multiple identifiers of a guide may be associated with each other. Information such as IM credentials, an email address, a phone number, a URL, a username, etc., of a guide may be identified which may allow the search system 130 to establish a communication session between a guide system and a user system, a resource system, a sponsor system and/or the search system 130.

When a guide registers with the search system 130 the guide may be associated with one or more topics, keywords, categories, profiles, and/or other information. Information associated with a guide may be stored in the database 120 and may be used for various purposes. Information associated with a guide may be used to rank requests, resources, results, advertisements, sponsors and/or other information which may be presented to the guide. In at least one embodiment, payment information is associated with a guide. In at least one embodiment, a guide may be required to undergo testing to determine whether a guide is able to perform any tasks which may be required by the search system 130. For example, a guide may be assigned to a role such as translator, transcriber, expediter, generalist, specialist, auditor, etc. A guide may be registered by a sponsor. A sponsor may provide compensation to a sponsored guide. A sponsor may designate personnel associated with the sponsor as responders.

Records may be maintained in the database 120 which may be used to record the status of various items. Such records may be used to aid the processing of requests and production of responses or answers. For example, a user may submit a request, which may describe a desired response, and provide access to information and/or materials needed to produce the response. Information indicated in a record may be combined with information in other records, and may be used to produce tables, as further described herein.

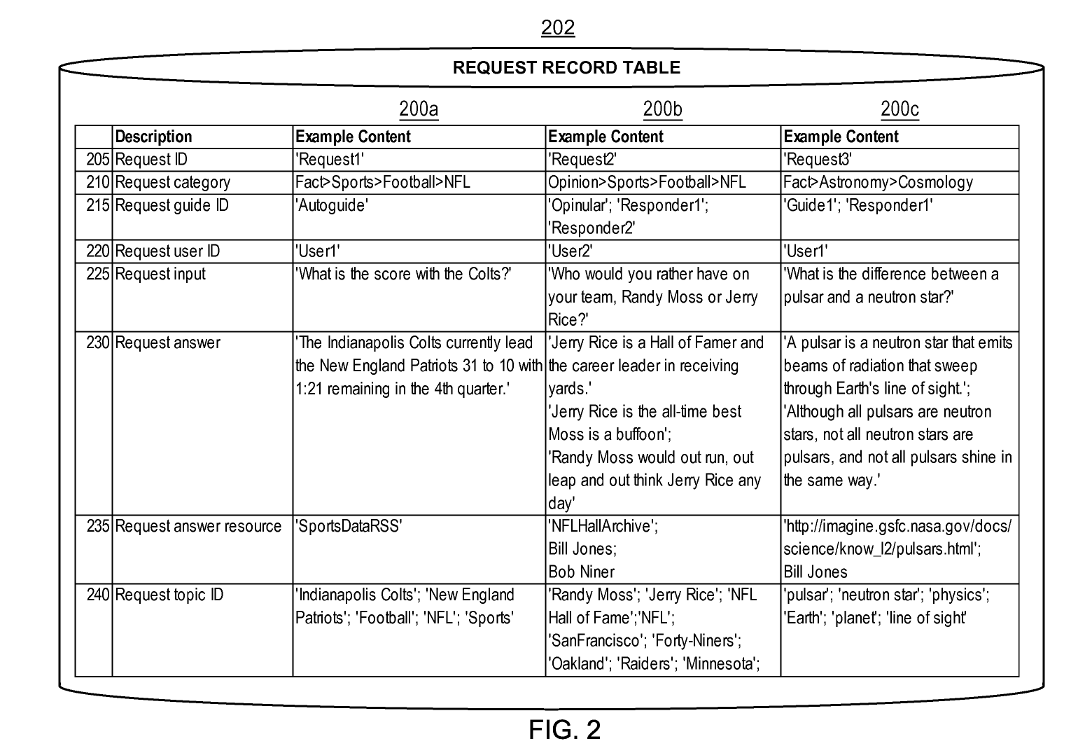

As illustrated in FIG. 2 an exemplary request record table 202 which may comprise a number of request records is provided. One or more request records may be associated with or resident in the database 120 (FIG. 1). While a few request records are depicted in FIG. 2, it is anticipated that many request records may be employed in operation of the embodiments. The request record table 202 may include information of requests which may be processed. The request records 200 may include a request ID field 205, a request category field 210, a request guide ID field 215, a request user ID field 220, a request input field 225, a request answer field 230, a request answer resource field 235 and a request topic ID field 240.

The request ID field 205 includes an identifier of a request which is preferably unique and is preferably used consistently. A request ID serves to distinguish a request record associated with a request from a request record associated with other requests. Any number of characters, numbers, and/or other indicators may be used to indicate a request ID. In at least one embodiment, a request ID associated with a request is included in the request ID field 205. In at least one embodiment, a random number is indicated in the request ID field 205. Using the example in FIG. 2, ‘Request1’ is the request ID associated with the request record 200a.

The request category field 210 may include information of a category associated with a request. Information indicated in the request category field 210 may be used to select an item associated with a request. For example, a category associated with a request may be used to rank responders who may be associated with the type of request. Likewise, a category associated with a request may be used to rank requests which may be presented to a guide. A category associated with a request may be determined based on factors such as keywords of a query, a profile of a user, a selection of a guide, a user history, an action of a user, an action of a responder, etc. A category associated with a system taxonomy may be indicated in the request category field 210. A category may be associated with a request automatically and/or using the assistance of a person. Using the example in FIG. 2, ‘Request2’ may be categorized as ‘Opinion>Sports>Football>NFL’ as indicated in the request record 200b. This may indicate that a person or item associated with the category ‘Opinion>Sports>Football>NFL’ may have a higher ranking for responding to ‘Request2’. A category of a request may be associated with a user submitting the request. Content of a request such as a keyword, named entity, topic, etc. may be used to assign a category or type to a request. A classification as subjective or objective may be required in order that a request may be submitted.

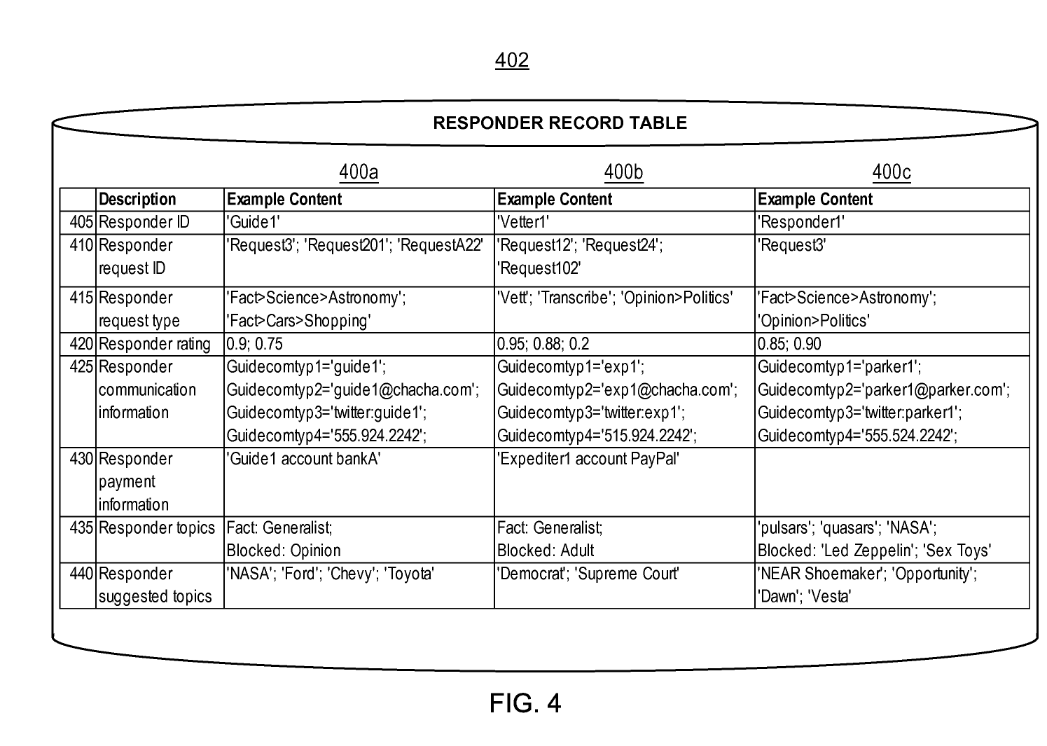

The request guide ID field 215 may include information of a number of guides associated with a request. Content of the request guide ID field 215 may be used to obtain information of a guide using a record such as the responder record 400b (FIG. 4). If a person is selected for a request, elects to receive a request, provides a response to a request, reviews a result of a request and/or completes a request, an identifier of the person may be indicated in the request guide ID field 215. Using the example in FIG. 2, ‘Opinular’, ‘Responder1’ and ‘Responder2’ are associated with ‘Request2’. This may for example indicate that ‘Request2’ has received an automated response from ‘Opinular’ and a response from ‘Responder1’ and ‘Responder2’.

The request user ID field 220 may include information of a number of users associated with a request. Content of the request user ID field 220 may be used to obtain information of a user associated with a request. For example, if a request is submitted by a user, an identifier of the user may be indicated in the request user ID field 220. A request may not be associated with a user. For example, the search system 130 (FIG. 1) may provide requests to persons which are not directly related to a user request. The search system 130 may provide a request to a responder based on a selection of the request by a user, a responder, an advertiser, etc. Using the example in FIG. 2, ‘User1’ is associated with ‘Request1’ and ‘Request3’ and ‘User2’ is associated with ‘Request2’. This may indicate that ‘Request1’ and ‘Request3’ were submitted by ‘User1’ while ‘Request2’ was submitted by ‘User2’.

The request input field 225 may include information of a request. Content of the request input field 225 may be provided to a person who accepts a request. Content of the request input field 225 may include any type of information. For example, a pointer to audio, video, text, and/or other media may be indicated in the request input field 225. As illustrated in FIG. 2, the query ‘What is the difference between a pulsar and a neutron star?’ is the request input associated with ‘Request3’, as indicated in the request record 200c. In at least one embodiment, the request input field 225 may indicate an original user request, a categorization, and a rewritten user request.

The request answer field 230 may include information of a response associated with a request. Content of the request answer field 230 may be provided to a user responsive to a request. Content of the request answer field 230 may be stored in the database 120 (FIG. 1). Content of the request answer field 230 may be reviewed and/or rated by a user, a guide, an answerer and/or an administrator. As illustrated in FIG. 2, the responses ‘A pulsar is a neutron star that emits beams of radiation that sweep through Earth's line of sight.’, and ‘Although all pulsars are neutron stars, not all neutron stars are pulsars, and not all pulsars shine in the same way.’ are associated with ‘Request3’ as illustrated in the request record 200c. While a text response to a query is used for the purposes of illustration, any type of media may be indicated in the request answer field 230. In at least one embodiment, a text response and a URL associated with a source of the text response may be indicated in the request answer field 230. In at least one embodiment, a responder may select a response which may cause a URL associated with the response to be inserted in the request answer resource field 235.

The request answer resource field 235 may include information of a resource associated with a request. Content of the request answer resource field 235 may be used for various purposes. A URL associated with a response may be used to determine whether a response is reliable. As illustrated in FIG. 2, a URL associated with an RSS feed is associated with ‘Request1’ which may indicate that a response associated with ‘Request1’ must be treated according to a pre-determined set of rules. For example, an opinion-type response associated with a particular responder may be more likely to be reused based on a rating of the responder. For example, if a user votes a response of a responder as positive a future response of the responder which is associated with a category of the response may be more likely to be presented. A response to a subjective request may be obtained from a resource such as the resource ‘NFLHallArchive’ indicated in the request answer resource field 235. If a response is not received from a responder within a predetermined time period of receipt of a request a response extracted from a resource may be provided. Likewise if less than a pre-determined number of responses is returned a response obtained from a resource may be provided. For example, a snippet including a named entity indicated in a user request may be extracted from a resource, which snippet may be provided responsive to a request. Using the example in FIG. 2, the sentence ‘Jerry Rice is a Hall of Famer and the career leader in receiving yards.’ Might be extracted from ‘NFLHallArchive’ based on the presence of the named entity ‘Jerry Rice’. As the query is subjective, the response may be accepted or relevant despite not being a direct answer to the user query.

The request topic ID field 240 may include information of a topic associated with a request. Content of the request topic ID field 240 may be determined based on a query, a response, a resource, a responder, a guide, a user, etc. associated with a request. For example, if a named entity such as ‘Randy Moss’ is included in a request, topics associated with ‘Randy Moss’ such as ‘Oakland’, ‘Raiders’, and ‘Minnesota’ which may be associated with ‘Randy Moss’ may be indicated in the request topic ID field 240 as indicated by the request record 200b.

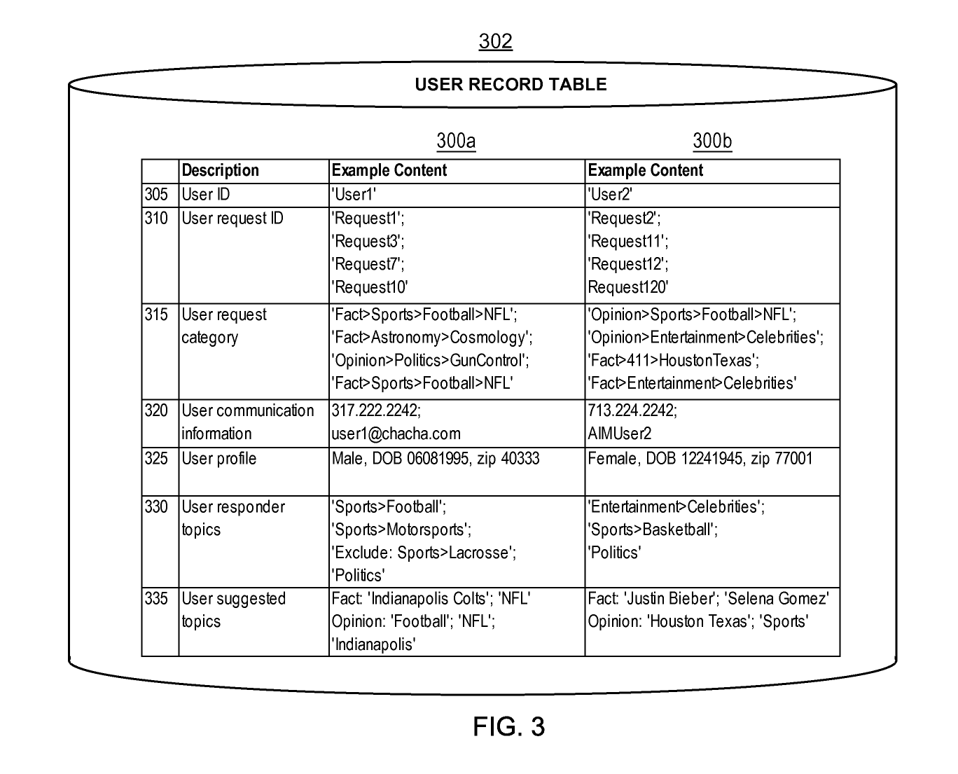

As illustrated in FIG. 3 an exemplary user record table 302, which may comprise a number of user records is provided. One or more user records may be associated with or resident in the database 120 (FIG. 1). The user record table 302 may include information of users. The user records 300 may include a user ID field 305, a user request ID field 310, a user request category field 315, a user communication information field 320, a user profile field 325, a user responder topics field 330, and user suggested topics field 335.

The user ID field 305 includes an identifier of a user which is preferably unique and is preferably used consistently. A user ID serves to distinguish a user record associated with a user from a user record associated with other users. Any number of characters, numbers, and/or other indicators may be used to indicate a user ID. In at least one embodiment, a random number is indicated in the user ID field 305. Using the example in FIG. 3, ‘User1’ is the user ID associated with the user record 300a.

The user request ID field 310 may include information of a number of requests associated with a user. A user request ID may be for example a pointer to a request record associated with a request submitted by a user. If a user submits a request, a request ID may be added to the user request ID field 310. Using the example illustrated in FIG. 3, ‘Request2’, ‘Request11’, ‘Request12’ and ‘Request120’ are associated with ‘User2’ as indicated in the user record 300b. This may indicate that ‘User2’ has submitted ‘Request2’, ‘Request11’, ‘Request12’ and ‘Request120’.

The user request category field 315 may include information regarding a category, type, etc., associated with a user request. For example, if a request is directed to a type of processing or a category, etc., a type, topic, and/or category associated with the processing may be indicated in the user request category field 315. In at least one embodiment, the user request ID field 310 and the user request category field 315 are linked by for example a pointer. In at least one embodiment, a user may be restricted to submitting questions which are subjective, objective, etc. A user may be restricted to accepting subjective, objective, etc., requests. Content of the user request category field 315 may be used to determine categories and/or topics of queries which may be directed to a guide, a responder, a user and/or a resource. Content of the user request category field 315 may be used to rank resources, guides, advertisements, etc. and may affect a probability that an item will be presented to a user, guide or responder.

The user communication information field 320 may include information of a number of communication services associated with a user. Any information which may be used to establish communication with a user may be indicated in the user communication information field 320. For example, a telephone number, an email address, an IM credential, a URL, a username, a password, and/or other communication information may be indicated in the user communication information field 320. Using the example in FIG. 3, the phone number ‘317.222.2242’ and the email ‘user1@chacha.com’ are associated with ‘User1’.

The user profile field 325 may include information of a profile associated with a user. For example, demographic, geographic, affiliation, personality, and/or other types of anthropic and/or other characteristic information may be associated with a user. A user may provide profile information as part of a registration process. User profile information may be obtained from a database provided by a third party. User profile information may be determined based on test, polling, query history, peer review, and/or other information associated with a user. Using the example illustrated in FIG. 3, ‘Female, DOB 12241945, zip 77001’ are associated with ‘User2’. Profile information may be used to match information provided by a user to other information. For example, a ranking of a guide for a query of a user may be adjusted based on a profile associated with the user. An answer might be modified based on geographic, demographic, etc., profile information of a user. A responder, guide and/or resource might have a different rating and/or ranking based on profile information of a user.

The user responder topics field 330 may include information of topics associated with a user for which the user may be selected as a responder. The user responder topics field 330 may include topics for which a user has elected to receive questions and/or topics for which a user has requested not to receive questions. Content of the user responder topics field 330 may be used to rate a user for a request. As illustrated in FIG. 3, a query associated with ‘Politics’ or ‘Sports’ might be directed to ‘User1’ and ‘User2’, but if the query is associated with ‘Sports>Lacrosse’ ‘User1’ would not receive the query. A user may elect to receive subjective and/or objective requests associated with a category or topic.

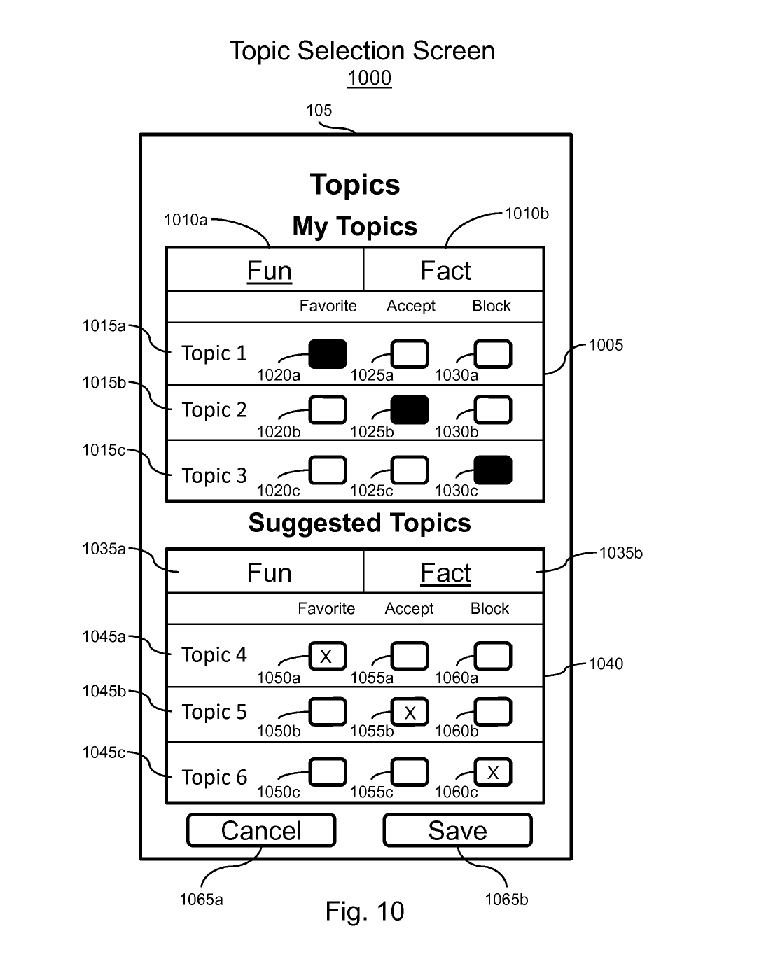

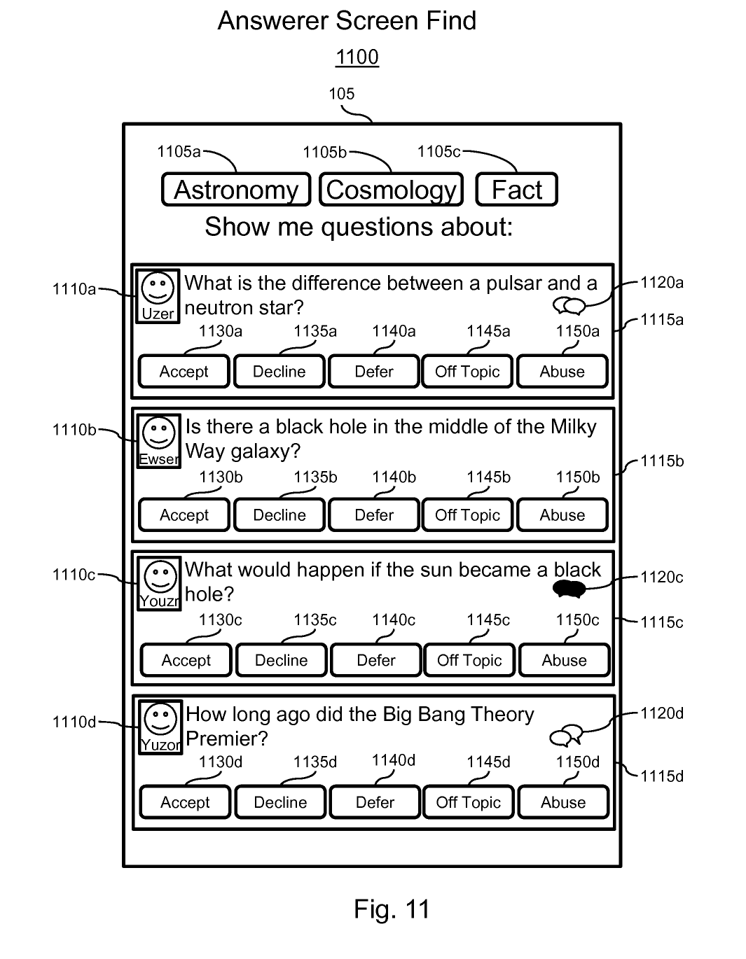

The user suggested topics field 335 may include information of topics suggested for a user. Topics may be associated with a type of query such as fact, opinion, conversational, etc. As illustrated in FIG. 3, factual queries associated with the topics ‘Justin Bieber’ and ‘Selena Gomez’ and opinion or subjective questions associated with the topics ‘Houston Tex.’ and ‘Sports’ might be suggested as registration topics for ‘User2’. For example, a factual query may require domain specific expertise on a topic, while an opinion query may require general interest in a topic. Topics indicated in the user suggested topics field 335 may be ranked for presentation to a user. A user may be explicitly invited to register for a topic as illustrated with respect to FIG. 10. A user may be implicitly invited to receive queries associated with a topic based on actions of a user via an interface such as that illustrated in FIG. 11. While a limited number of topics are used for the purposes of illustration, it is envisioned that large numbers of topics may be used, and that various types may be assigned in the process of distribution of requests.

As illustrated in FIG. 4 an exemplary responder record table 402 which may comprise a number of responder records is provided. One or more responder records may be associated with or resident in the database 120 (FIG. 1). The responder record table 402 (FIG. 4) may include information of responders. The responder records 400 may include a responder ID field 405, a responder request ID field 410, a responder request type field 415, a responder rating field 420, a responder communication information field 425, a responder payment information field 430, a responder topics field 435 and a responder suggested topics field 440.

The responder ID field 405 includes an identifier of a responder which is preferably unique and is preferably used consistently. A responder ID serves to distinguish a responder record associated with a responder from a responder record associated with other responders. Any number of characters, numbers, and/or other indicators may be used to indicate a responder ID. In at least one embodiment, a random number is indicated in the responder ID field 405. In at least one embodiment, a pseudonym selected by a responder may be indicated in the responder ID field 405. A first and last name of a responder may be indicated in the responder ID field 405. Using the example in FIG. 4, ‘Guide1’ is the responder ID associated with the responder record 400a.

The responder request ID field 410 may include information of a number of requests associated with a responder. Content of the responder request ID field 410 may be used to obtain information of a request. For example, if a user request has been determined to require a number of requests to be performed, the search system 130 (FIG. 1) may assign a unique ID to the requests and may distribute information of the requests to responders. Using the example in FIG. 4, ‘Vetter1’ is associated with ‘Request12’, ‘Request24’ and ‘Request102’ as indicated in the responder record 400b. This may indicate that ‘Vetter1’ has responded to those requests by for example classifying, transcribing, clarifying, etc.

The responder request type field 415 may include information of a number of types of requests which may be processed by a responder. For example, a category, topic and/or keyword associated with a request, a type of request, temporal information associated with a request, etc., which may be used to determine if a responder is to be presented with a request may be indicated in the responder request type field 415. In at least one embodiment, a responder may be assigned to a particular type of request as part of a registration process. A responder may select a type of request which the responder may receive. A responder may be required to pass a test in order to be associated with a type of request. For example if a responder is to provide responses to factual queries, an assessment of a responder's knowledge of a topic may be performed. A responder may be assigned to a role such as vetter, expediter, searcher, etc., which may be indicated in the responder request type field 415. A request indicating a keyword may be directed to a responder. Using the example in FIG. 4, ‘Responder1’ is associated with ‘Fact>Science>Astronomy’ and ‘Opinion>Politics’ as indicated in the responder record 400c. This may for example indicate that ‘Responder1’ may be presented with and/or selected to respond to requests indicating those classifications, topics, etc.

The responder rating field 420 may include information of a number of ratings associated with a responder. For example, quality, speed, peer review, response time, response frequency, etc., may be used to determine a rating of a responder. A rating of a responder may be used for purposes such as determining compensation for the responder (e.g. bonus points), selecting a responder to respond to a request, matching a request to a responder, etc. In at least one embodiment, the responder request type field 415 and the responder rating field 420 may be linked by, for example, a pointer. Using the example in FIG. 4, ‘Guide1’ and ‘Responder1’ are associated with the type ‘Fact>Science>Astronomy’ and ‘Vetter1’ and ‘Responder1’ are associated with the type ‘Opinion>Politics’. A response associated with ‘Guide1’ may be more likely to be provided responsive to a request associated with ‘Fact>Science>Astronomy’, while ‘Responder1’ might be more likely to be provided with an opportunity to respond to a request associated with ‘Opinion>Politics’ based on the ratings indicated in the responder rating field 420.

The responder communication information field 425 may include information of a number of communication services associated with a responder. For example, a user name and password, an email address, an IM credential, a phone number, a web page, a physical address, etc., may be indicated in the responder communication information field 425. Using the example illustrated in FIG. 4, ‘Guide1’ is associated with the login ID ‘guide1’, the email ‘guide1@chacha.com’, the Twitter account ‘twitter.guide1’, and the phone number ‘555.924.2242’. This may indicate that ‘Guide1’ may be contacted using the associated communication services.

The responder payment information field 430 may include information of a payment method associated with a responder. For example, banking information, a PayPal® account, a Western Union® account, etc., may be indicated in the responder payment information field 430. Content of the responder payment information field 430 may be used to provide compensation to a responder. For example, payment may be made by Automated Clearing House (ACH), wire transfer, etc., using information indicated in the responder payment information field 430. If a responder is not compensated, the responder payment information field 430 may be blank. As illustrated in FIG. 4, ‘Expediter1 account PayPal’ is associated with ‘Vetter1’ as indicated by the responder record 400b.

The responder topics field 435 may include information on topics which may be associated with a responder. The information associated with the responder topics may be topics for which the responder has agreed to accept requests or topics which the responder has blocked and thus will not be offered requests associated with the topics. As illustrated in FIG. 4 ‘pulsars’, ‘quasars’, ‘NASA’, are topics for which ‘Responder1’ may receive notifications and blocked topics for which ‘Responder1’ may not receive notifications include ‘Led Zeppelin’, and ‘Sex Toys’. A responder may be ranked based upon topics associated with a responder. A higher ranking for a topic may increase a probability that a responder will be notified of a request. Topics associated with a responder may be ranked. A higher ranking topic may affect a probability that a responder may be notified of a request associated with a topic. For example, if a responder is associated with a high ranking topic, the responder may be more likely to be notified or selected or chosen to respond to a request associated with the high ranking topic or keyword.

The responder suggested topics field 440 may include information of topics which may be recommended or suggested to a responder. Content of the responder suggested topics field 440 may include topics for which a responder has not registered for which the responder is likely to accept queries. For example, as indicated in the responder record 400a, ‘Guide1’ may be willing to accept queries associated with ‘NASA’, ‘Ford’, ‘Chevy’, and ‘Toyota’. Content of the responder suggested topics field 440 may be modified based on actions of a responder. For example, if a query associated with a topic indicated in the responder suggested topics field 440 is accepted by a responder, a ranking of a topic may be increased. Likewise, if a topic identified in the responder suggested topics field 440 is explicitly declined by a responder, a ranking of a topic for the user may be decreased. If a topic indicated in the responder suggested topics field 440 is accepted as a favorite, a ranking of topics associated with the topic may be increased. If a responder blocks a topic, a ranking of topics associated with the topic may be adjusted.

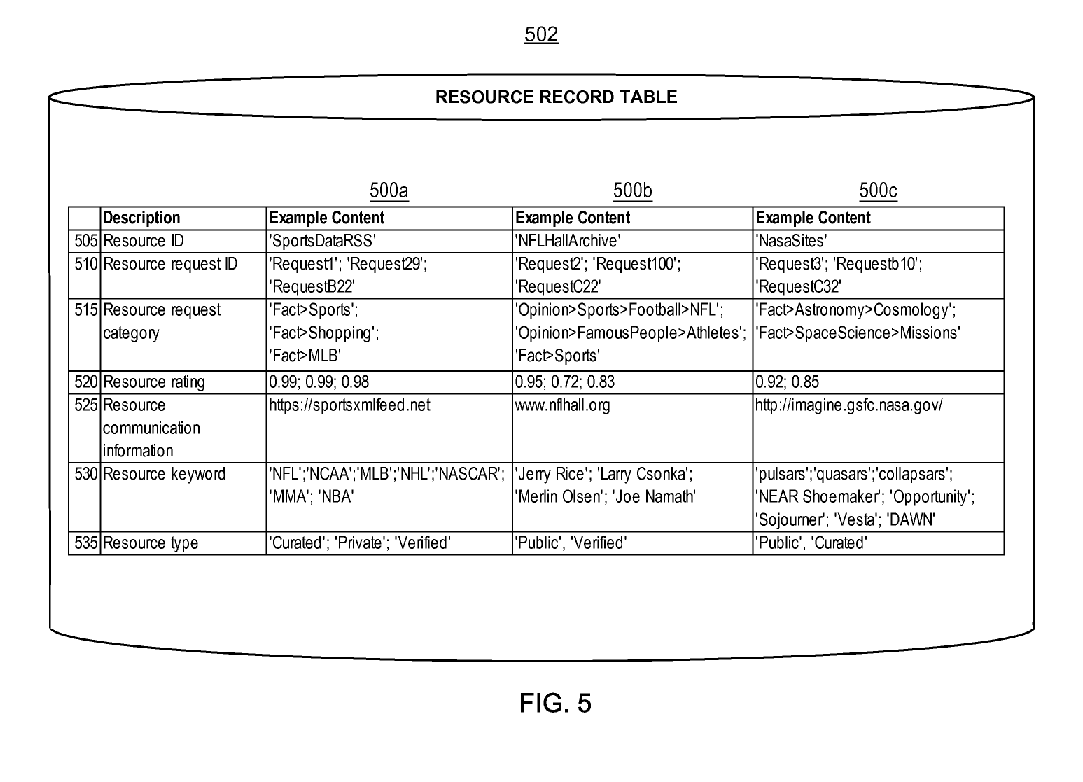

As illustrated in FIG. 5 an exemplary resource record table 502 which may comprise a number of resource records is provided. One or more resource records may be associated with or resident in the database 120 (FIG. 1). The resource record table 502 (FIG. 5) may include information of resources. The resource records 500 may include a resource ID field 505, a resource request ID field 510, a resource request category field 515, a resource rating field 520, a resource communication information field 525, a resource keyword field 530, and a resource type field 535.

The resource ID field 505 includes an identifier of a resource which is preferably unique and is preferably used consistently. A resource ID serves to distinguish a resource record associated with a resource from a resource record associated with other resources. Any number of characters, numbers, and/or other indicators may be used to indicate a resource ID. Using the example in FIG. 5, ‘SportsDataRSS’ is the resource ID associated with the resource record 500a.

The resource request ID field 510 may include information of a number of requests associated with a resource. Content of the resource request ID field 510 may be used to obtain information of a request. For example, if a resource has been used to respond to a request, an identifier of the request may be indicated in the resource request ID field 510. Using the example in FIG. 5, ‘Request2’, ‘Request100’ and ‘RequestC22’ are associated with the resource ‘NFLHallArchive’ as indicated in the resource record 500b. This may indicate that ‘NFLHallArchive’ has been utilized to respond to ‘Request2’, ‘Request100’ and ‘RequestC22’.

The resource request category field 515 may include information of a number of categories of requests which may be processed by a resource. For example, a category and/or keyword associated with a request, a type of request, profile, etc., which may be used to determine if a resource and/or a result obtained from a resource is to be presented to a responder for a request may be indicated in the resource request category field 515. In at least one embodiment, a resource may be assigned to a category of request as part of a registration process. A resource may be associated with a user, a group of users, an access right, an advertiser or sponsor, etc. A provider of a resource may select a type and/or category of request for which the resource may be used and/or required. A resource may be associated with a category based on a selection by an administrator, based on success rates of obtaining or providing answers, etc. Using the example in FIG. 5, ‘NASASites’ is associated with the category ‘Fact>Astronomy>Cosmology’ and ‘Fact>SpaceScience>Missions’ as indicated by the resource record 500c.

The resource rating field 520 may include information of a number of ratings associated with a resource. For example, a rating of a resource may be based on ratings of answers produced using the resource, a contractual agreement, an affiliation, temporal information such as time spent by guides, etc. A rating of a resource may be used to select a resource which is provided to a searcher, responder, or guide, to rank a response associated with a resource, etc. In at least one embodiment, the resource request category field 515 and the resource rating field 520 may be linked by, for example, a pointer. Using the example in FIG. 5, ‘SportsDataRSS’ has a rating of ‘0.99’ associated with ‘Fact>Sports’, and ‘NFLHallArchive’ has a rating ‘0.83’, associated with “Fact>Sports’ which may for example indicate that ‘SportsDataRSS’ is more likely to produce an acceptable response for that category. A resource may have a rating corresponding to various categories, topics, types of information, types of tasks, keywords, etc.

The resource communication information field 525 may include information of a number of communication services associated with a resource. For example, a user name and password, an email address, an IM credential, a phone number, a web page, a physical address, etc., may be indicated in the resource communication information field 525. A communication service indicated in the resource communication information field 525 may for example be used to indicate a service by which a resource may be accessed. Using the example illustrated in FIG. 5, the URL <<‘https://sportsxmlfeed.net>> is associated with ‘SportsDataRSS’. This may indicate that a query associated with ‘Fact>Sports’ may be submitted to that URL by for example an API.

The resource keyword field 530 may include information of a number of keywords associated with a resource. A match to a keyword indicated in the resource keyword field 530 may affect a probability that a request will receive a response associated with a resource. For example, a match may prohibit a query from receiving a result from a resource, may increase a ranking of a resource, may be used to associate a category with a request, may identify a resource to be provided to a guide, responder, vetter, etc. In at least one embodiment, keywords included in requests for which a resource has provided an answer may be more highly ranked for a category associated with the query and the resource. Content of the resource keyword field 535 may be obtained based on analysis of media associated with a resource. For example, text, metadata, images, etc. which are associated with a resource may be analyzed to identify, rate, rank, categorize, etc. keywords and/or topics which may be associated with a responder.

The resource type field 535 may include information of a number of types or characteristics associated with a resource. A type may include an indication of an access right, a commercial arrangement, a preference, quality of content, source of content, etc. A searcher may elect to associate a resource with a type. A system administrator may associate a type with a resource. A provider of a resource may designate a type associated with the resource as part of a registration process. Using the example in FIG. 5, ‘SportsDataRSS’ is a ‘Verified’, ‘Private’, ‘Curated’ resource. This may indicate that content of the resource is controlled, that the resource is not accessible to the general public, and that the content of the resource is verified to be correct.

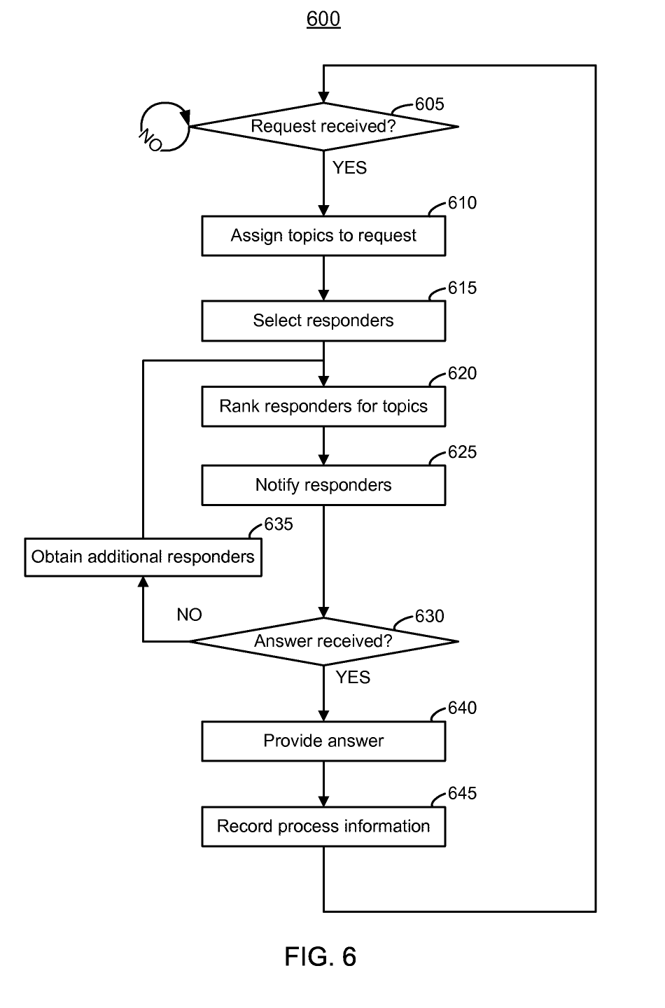

As illustrated in FIG. 6, a process 600 for providing an answer is provided. The process 600 may be performed in whole or in part by any suitable element of the system 100 (FIG. 1). In at least one embodiment, the process 600 is operative on a server associated with the search system 130. A request may be a request for an automated answer, a human assisted answer and/or a combination thereof.

In operation 605 (FIG. 6) a determination is made as to whether a request is received. If it is determined in operation 605 that a request is not received, control remains at operation 605 and process 600 continues. If it is determined in operation 605 that a request is received, control is passed to operation 610 and process 600 continues.

The determination in operation 605 may be made using various criteria. In at least one embodiment, if a message is received at a system associated with the search system 130 (FIG. 1), it may be determined that a request is received. For example, if an email message, an SMS, EMS, and/or MMS message, an IM, an IP message, and/or a voice message is received at an address associated with the search system 130, it may be determined that a request is received. A request may be received based on chronological information. For example, if it is close to breakfast time in a particular location, a request to know the length of a waiting queue at a restaurant may be generated which may be directed to persons associated with the restaurant. If a message is received at a server associated with the search system 130, it may be determined that a request is received.

In operation 610 topics are assigned to a request. Topics may be assigned to a request in various ways. Content of a request may be used to associate a topic with a request. For example, keywords of a request may be used to identify a topic associated with a request, a pronoun reference of a request may be resolved to a named entity which is used to select a topic associated with a request. A profile of a user associated with a request may be used to associate a topic with a request. For example, a demographic, geographic, topical, etc. parameter of a user profile may be used to associate a topic with a request. Any criteria and/or combination of criteria may be used to assign a topic to a request. Control is passed to operation 615 and process 600 continues.

In operation 615, responders are selected. A responder may be selected based on various criteria. A responder may be selected based on availability of a responder, a topic associated with a request, rating of a responder, ranking of a topic, location, a preference for a topic, blocking of a topic, etc. Any user, guide, or person may be selected as a responder. In at least one embodiment, if a request has been offered to a number of responders, a guide may be selected. A guide may be selected as a responder if an expediter or vetter has reviewed a request. A guide may not be selected as a responder based on a user, topic, type, etc. associated with a request. For example, if a request is an opinion request, a guide may not be selected as a responder. Control is passed to operation 620 and process 600 continues.

In operation 620 responders are ranked for topics. A responder may be ranked based on a responder request type, responder rating, responder topic, query topic, availability, etc. Ranking of responders may be based on any suitable criteria. Control is passed to operation 625 and process 600 continues.

In operation 625, responders are notified. Notification of responders may be performed via any communication service associated with a responder such as email, instant messaging, SMS, voice call, MMS, IP notifications, etc. For example, a responder may be notified of a request via text message. A responder may be notified based on presence information. For example, if ‘presence’ information indicates that a responder is currently logged in to an application running on a responder device, a notification may be delivered via the device. A responder may be notified via services such as SMS which do not provide presence information. A notification may be a specific notification of a query, a notification of a category, topic, etc., and/or a general notification that requests are available. Control is passed to operation 630 and process 600 continues.

In operation 630, a determination is made as to whether an answer is received. If it is determined in operation 630 that an answer is not received, control is passed to operation 635 and process 600 continues. If it is determined in operation 630 that an answer is received, control is passed to operation 640 and process 600 continues.

The determination in operation 630 may be made using various criteria. If an answer is received from a predetermined number of responders it may be determined that an answer is received. If a time interval has elapsed, it may be determined that an answer is received. If a user has accepted a response, sent a message to a responder, or otherwise responded to an answer, it may be determined that an answer is received. If a number of responders have declined a request, or indicated that a request is inappropriate, it may be determined that an answer is received.

In operation 635, additional responders are obtained. Additional responders may be selected based on various criteria. A responder may be selected based on availability of a responder, a topic associated with a request, rating of a responder, ranking of a topic, location, a preference for a topic, blocking of a topic, etc. Any user, guide, or person may be selected as a responder. Control is passed to operation 620 and process 600 continues.

In operation 640, an answer is provided. Any number of answers may be provided. A highest ranking objective answer may be provided. A sponsored objective answer may be provided. A sponsored subjective answer may be provided. Control is passed to operation 645 and process 600 continues.

In operation 645, process information is recorded. Information of a request, an objective answer, a subjective answer, a category, a keyword, a resource, a user, a sponsor, a guide, a responder, a rating, a ranking, etc. may be recorded. A stored response may be rated, ranked, or deleted. In at least one embodiment, process information is recorded in the database 120 (FIG. 1). Control is passed to operation 605 and process 600 continues.

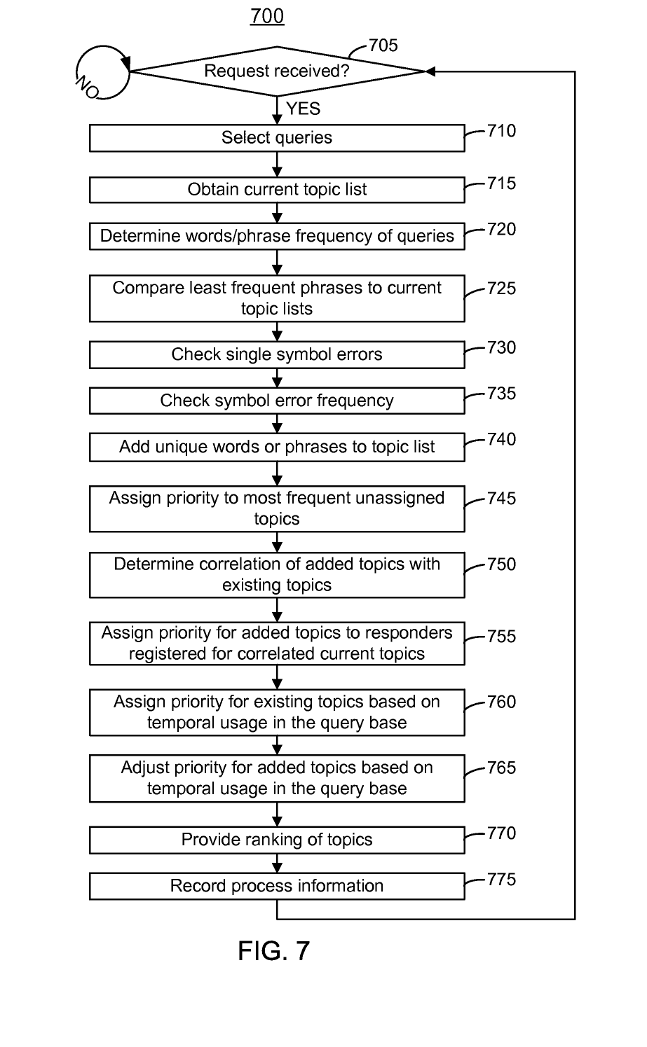

As illustrated in FIG. 7, a process 700 for ranking topics is provided. The process 700 may be performed in whole or in part by any suitable element of the system 100 (FIG. 1). In at least one embodiment, the process 700 is operative on a server associated with the search system 130.

In operation 705 (FIG. 7) a determination is made as to whether a request is received. If it is determined in operation 705 that a request is not received, control remains at operation 705 and process 700 continues. If it is determined in operation 705 that a request is received, control is passed to operation 710 and process 700 continues.

The determination in operation 705 may be made using various criteria. In at least one embodiment, if a message is received at a system associated with the search system 130 (FIG. 1), it may be determined that a request is received. For example, if an email message, an SMS, EMS, and/or MMS message, an IM, an IP message, and/or a voice message is received at an address associated with the search system 130, it may be determined that a request is received. In at least one embodiment, if a message is received at a server associated with the search system 130, it may be determined that a request is received.

In operation 710 queries are selected. Queries may be selected from a corpus of queries in various ways. For example, a corpus of queries selected by a group of persons such as guides or vetters might be selected. A corpus of queries associated with a time interval might be selected. For example queries during a previous seven day time period might be selected. A corpus of queries associated with a topic, category, location, language, etc., might be selected. For example, queries associated with a city might be selected. Control is passed to operation 715 and process 700 continues.

In operation 715 a current topic list is obtained. A list of current topics may include topics associated with requests or queries which have been recently asked, answered, etc. A topic list may be stored in the database 120 (FIG. 1) and may for example include phrases which are least frequently encountered in a corpus such as historical queries, resources selected by guides, resources selected automatically based on techniques such as spidering, etc. Topics may be selected based on a match to a request which is received. Control is passed to operation 720 and process 700 continues.

In operation 720, word/phrase frequency is determined for queries. For example, an inverse word frequency may be determined for a corpus wherein one or more words in succession are treated as a single word or token. If a token appears infrequently in a corpus the token may be more probable or likely to have a higher significance in a query. Control is passed to operation 725 and process 700 continues.

In operation 725 least frequent phrases are compared to a current topic list. Phrase frequency may be based on frequency of occurrence of an element of a corpus. For example, if an equivalent correction would cause a user input to match two elements of a corpus, the element which occurs most frequently in user requests, which is most registered or favorite, which is blocked least, etc. might be considered to be more frequent. Control is passed to 730 and process 700 continues.

In operation 730 single symbol errors are checked. Single symbol errors are checked to determine if a user may have input a symbol incorrectly into the query. For example, if a user input matches an element of a corpus such as the topic list when a letter is transposed, substituted, deleted, etc. that element of the corpus might be determined to be equivalent to an existing topic. Control is passed to operation 735 and process 700 continues.

In operation 735 symbol error frequency is checked. Frequency of a symbol error may indicate that a topic which includes a symbol error when compared to an existing topic is a new topic and should be added to the list and may not be an error. For example, if an identical symbol error occurs greater than a given number, frequency, etc. of times, it may be determined that the symbol error is not an error and that a new topic is indicated. Control is passed to operation 740 and process 700 continues.

In operation 740 unique words or phrases are added to a topic list. Users may be permitted to add topics to a corpus of topics. If a search facility does not provide a match to a topic desired by a user, a user may be provided with a facility for requesting that the topic be added to a corpus of topics. A topic suggested by a user may be subject to review. A review may be based on criteria such as overlap with existing topics, breadth or specificity of a topic, a number of users requesting to add a topic or similar topic, a number of requests indicating the topic, whether the topic has been blocked, whether a user has answered questions which would be associated with a topic, etc. A review may be based on an assessment by a system administrator, voting by users, voting by a selected group of users, presentation of the topic to users, a number of users who register for the topic during a time period, etc. Control is passed to operation 745 and process 700 continues.

In operation 745 a priority is assigned to the most frequent unassigned topics. Topics which are high priority and unassigned may be more likely to be offered to users who show an interest in responding to topics which are correlated to the unassigned topics. Assignment of unassigned topics may be done in the order of priority, so that topics which occur often but are not assigned to a responder will be more likely to be offered and/or accepted by a responder. Control is passed to operation 750 and process 700 continues.

In operation 750 a correlation of added topics to existing topics is determined. If a request is seeking information regarding a topic and a responder provides an answer, a topic which is strongly correlated to the topic may be offered as a suggested topic. For example, if a user responds to a request regarding a member of a sports team, the name of the team, and/or the names of other members of that team might be offered as suggested topics while the names of other teams might not be suggested topics. If a request is determined to be seeking subjective information or opinion, a more general topic might be suggested to a responder if an answer is provided. For example, if an answerer responded to a request seeking subjective information about a sports team, a name of another team, a name of the league, or the name of other sports teams in a nearby geographic location might be offered as suggested topics to the user when receiving subjective requests. Similar relationships might be applied to structured data such as movies, music, politics, industry, science, entertainment, technology, etc. Correlation of topics may be determined based on analysis of a corpus of queries, content, responder topics, etc. Control is passed on to operation 755 and process 700 continues.

In operation 755 a priority for added topics is assigned to responders registered for correlated current topics. Responders may be registered for any number of topics which may be correlated to topics added to a topics list. For example, a responder may be registered for the topic ‘computers’ and a correlated topic of ‘software’ may be introduced and a responder registered for computers may be given a high priority to be offered queries associated with the ‘software’ topic or to register for the ‘software’ topic. Correlation of topics may be determined in various ways. For example, if phrases appear in the same document, correlation of the phrases may be increased. Control is passed on to operation 760 and process 700 continues.

In operation 760 a priority for existing topics is assigned based on temporal usage in the query base. Topics associated with more recent requests may be assigned a higher priority than topics asked less frequently or less recently. For example, a topic that has been associated with multiple requests may be given a higher priority than a topic which has not been associated with a request in a group of selected queries. Control is passed on to operation 765 and process 700 continues.

In operation 765 a priority for added topics is adjusted based on temporal usage in the query base. Priority of an added topic may change as new queries are presented. Queries or requests submitted may change based on what is popular amongst users at any given time and the topics list and/or importance of topics may change to reflect such fluctuations. Control is passed on to operation 770 and process 700 continues.

In operation 770, a ranking of topics is provided. Topics may be ranked according to single symbol errors, symbol error frequency, words/phrases frequently used, temporal usage, etc. A ranking of topics may be used to determine which topics may be presented to responders as suggested topics, may be used to determine importance of a topic in selecting a responder, may be used to route requests which are associated with topics which are not linked to responders, etc. Control is passed to operation 775 and process 700 continues.

In operation 775, process information is recorded. Information of a topic list, a query list, a selection criterion, a user, a guide, a responder, a rating, a ranking, etc. may be recorded. A rating, ranking and/or content of a topic, response and/or request may be recorded. In at least one embodiment, process information is recorded in the database 120 (FIG. 1). Control is passed to operation 705 and process 700 continues.

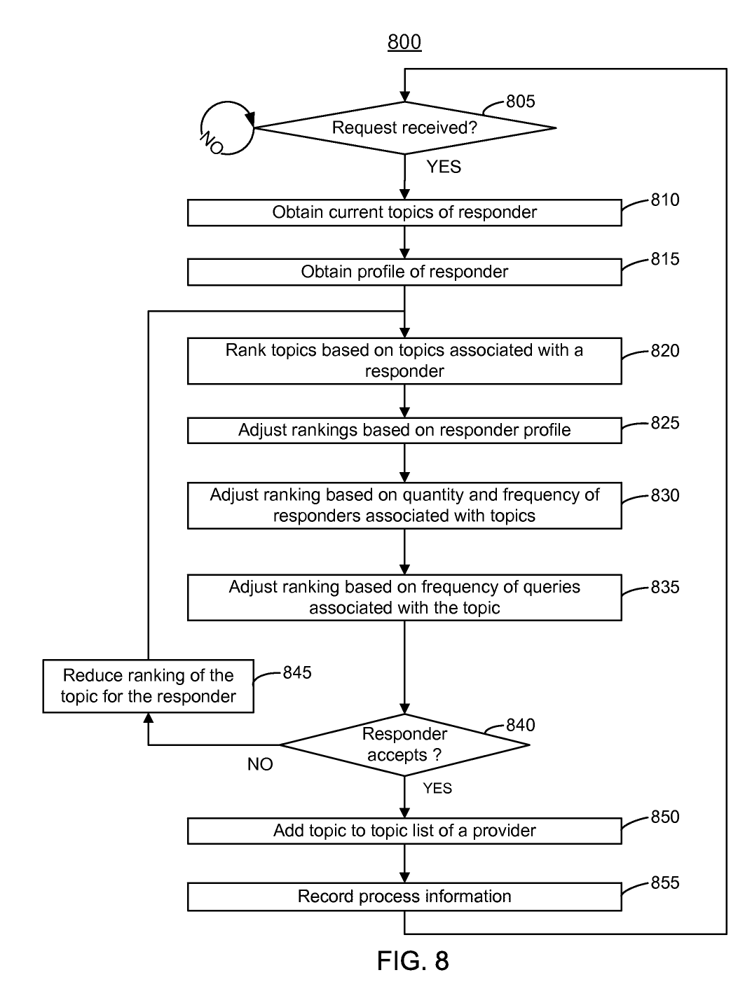

A process 800 for presenting a topic to a responder is illustrated in FIG. 8. The process 800 may be performed in whole or in part by any suitable element of the system 100 (FIG. 1). In at least one embodiment, the process 800 is operative on a server associated with the search system 130.

In operation 805 (FIG. 8) a determination is made as to whether a request is received. If it is determined in operation 805 that a request is not received, control remains at operation 805 and process 800 continues. If it is determined in operation 805 that a request is received, control is passed to operation 810 and process 800 will continue.

In operation 810 current topics of a responder are obtained. For example a responder record such as the responder records 400a-400c (FIG. 4) may be examined to determine topics associated with a responder. A list of current topics associated with a responder may be used to determine topics for which a responder has previously indicated an interest, indicated a preference, and/or has indicated that a topic is to be blocked. Control is passed to operation 815 and process 800 will continue.

In operation 815 a profile of a responder is obtained. Responder profile information may include demographic, geographic, personality, affiliation, etc., information of a responder. Profile information of a responder may include information regarding responsiveness of a responder. For example, a time period during which a responder is most likely to accept a request, a number of requests typically accepted, etc. may be indicated in a profile of a responder. Control is passed to operation 820 and process 800 continues.

In operation 820 topics are ranked based on topics associated with a responder. For example, if a responder is already associated with a topic which is correlated to a highly ranked topic which is not associated with a responder, the highly ranked topic may be highly ranked for the responder. Similarly if a responder has blocked a topic, if a highly ranked topic is correlated to a blocked topic, the highly ranked topic may be less likely to be offered to the responder. If a responder has submitted queries topics associated with responses to the responder's queries may be ranked highly for the responder. Control is passed to operation 825 and process 800 will continue.

In operation 825 ranking is adjusted based on a responder profile. For example if responders of a specific gender, age, religion, etc. are more likely to respond to queries associated with a topic, a ranking of a topic may be adjusted based on gender, age, religious, psychometric, etc. information which is associated with a responder profile. Any information of a responder profile may be used to adjust a ranking of a topic. Control is passed to operation 830 and process 800 continues.

In operation 830 ranking is adjusted based on quantity and frequency of responders associated with the topic. If a large number of responders accept requests associated with a topic, a ranking of the topic for a responder may be reduced. If a small number of responders are associated with a topic, but a high number of responders are available a high percentage of the time, a ranking of the topic may be reduced. If a topic is not associated with a responder, a ranking of a topic may be increased. If a rating of responders associated with a topic is low, a ranking of a topic may be increased. Control is passed to operation 835 and process 800 continues.

In operation 835 ranking is adjusted based on frequency of queries associated with the topic. If queries are frequently associated with a topic, a ranking of a topic may be increased. If queries associated with a topic are frequently answered by guides or compensated answerers a ranking of a topic may be increased. If queries associated with a topic are frequently answered by automation, a ranking of a topic may be reduced. Control is passed to operation 840 and process 800 continues.

In operation 840, a determination is made as to whether responder accepts a topic. If it is determined in operation 840 that a responder does not accept a topic, control is passed to operation 845 and process 800 continues. If it is determined in operation 840 that a responder accepts a topic, control is passed to operation 850 and process 800 continues.

The determination in operation 840 may be made using various criteria. For example, inputs from a responder using an interface such as the GUI 1000 (FIG. 10) may be used to determine whether a responder accepts a topic. If a responder responds to a number of requests associated with a topic, it may be determined that a responder accepts a topic. If a responder blocks a request, indicates that a request is off topic, etc. it may be determined that a responder accepts a topic. Acceptance by a responder is not limited to accepting a request associated with a topic. For example, a responder may accept a topic as a favorite, may accept to block a topic, etc. A responder may be presented with requests using a GUI such as the GUI 1100 (FIG. 11). Actions of a responder regarding a request may be used to determine whether a responder accepts a topic. For example, if a responder elects to decline a number of requests associated with a topic, it may be determined that a responder has not accepted a topic. Any suitable criteria may be used to determine whether a responder accepts a topic.

In operation 845 a rank of a topic for a responder is reduced. For example, if a topic has been presented to a responder and the responder declines to accept requests associated with the topic, a ranking of the topic may be reduced. Control is passed to operation 820 and process 800 continues.

In operation 850 a topic is added to a topic list of a provider. A topic may be added as a favorite, acceptable, and/or blocked topic. A rating or ranking of a responder for an added topic may be determined. Control is passed to operation 855 and process 800 continues.

In operation 855 process information is recorded. A ranking of topics for a responder may be recorded. Information of a number of times a topic has been presented to responders may be recorded. Information of a number of times a request is associated with a topic may be recorded. Information of a responder, request, user, resource, topic, etc. may be stored. In at least one embodiment, process information is recorded in the database 120 (FIG. 1). Control is passed to operation 805 and process 800 continues

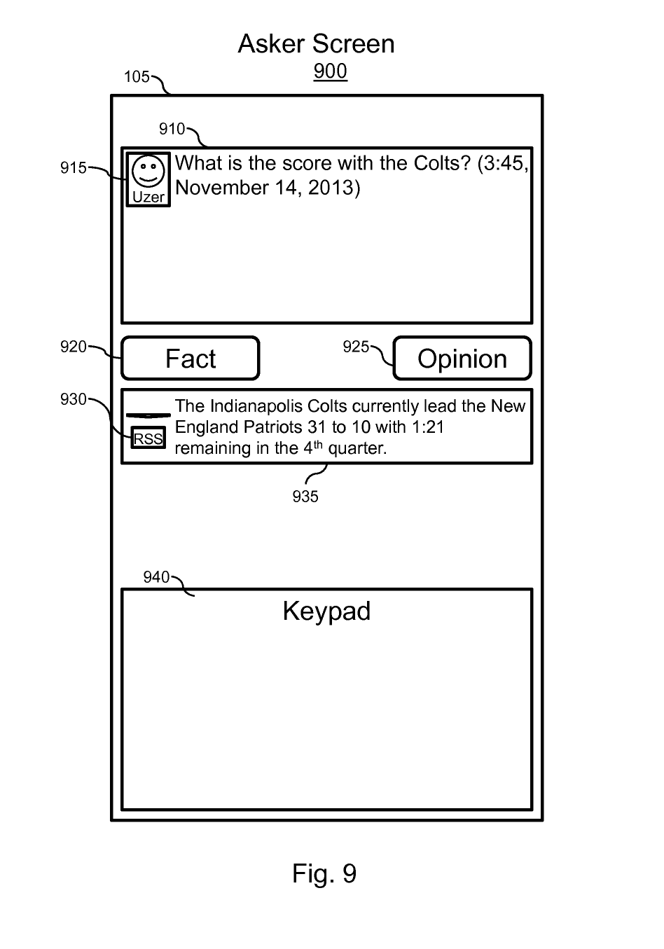

As illustrated in FIG. 9 an exemplary GUI 900 for submitting a request is provided. The query submission GUI 900 may be provided to a user. The GUI 900 may be presented using a system such as the user system 105 (FIG. 1). The GUI 900 may be used to submit any type of request. The GUI 900 may include a query entry area 910, a user identifier 915, a factual query indicator 920, an opinion query indicator 925, a responder indicator 930, a response indicator 935, and a user input control 940.

The request entry area 910 may be used to indicate information of a request. The user indicator 915 may be used to indicate information of a user submitting a request. The factual query indicator 920 may be used to indicate that a request is a request for factual information. Activation of the factual query indicator 920 may cause a request indicated in the request entry area 910 to be associated with the type ‘Fact’. Activation of the opinion query indicator 925 may indicate that a request is a request for subjective information. The responder indicator 930 may be used to indicate a source of a response. The response indicator 935 may be used to indicate a response associated with a request indicated in the request indicator 910. The user input control 940 may be used to submit a request. While a keypad is used for purposes of illustration, any user input device which is well known in the art may be used to implement the user input control 940.

An exemplary GUI 1000 for registering topics is illustrated in FIG. 10. The GUI 1000 may be provided to an answerer via a device such as the user system 110 (FIG. 1) or the guide system 135 to register for and manage topics. The GUI 1000 may include a registered topic area 1005, registered topic type indicators 1010a, 1010b, registered topic indicators 1015a-1015c, registered favorite indicators 1020a-1020c, registered acceptance indicators 1025a-1025c, registered blocking indicators 1030a-1030c, suggested topic area 1040, suggested topic type indicators 1035a, 1035b, suggested topic indicators 1045a-1045c, suggested favorite indicators 1050a-1050c, suggested acceptance indicators 1055a-1055c, suggested blocking indicators 1060a-1060c, and action controls 1065a, 1065b.

The registered topic area 1005 may include information of topics for which a responder has elected to receive requests and/or block requests. The registered topic type indicators 1010a, 1010b may be used to select a type associated with a registered topic. Activation of the ‘Fun’ registered topic indicator 1010a may cause information of topics associated with opinion type queries to be provided. Activation of the ‘Fact’ registered topic indicator 1010b may cause information of topics associated with objective or factual queries to be provided. The ‘Fun’ registered topic type indicator 1010a is active as indicated by the underline in FIG. 10. The registered topic indicators 1015a-1015c may be used to indicate information regarding a registered topic. For example, the ‘Topic 1’ registered topic indicator 1015a may be used to indicate registration status of a responder for ‘Topic 1’. The registered favorite indicators 1020a-1020c may be used to indicate whether a user has indicated that a topic is a favorite. For example the filled rectangle in the registered favorite indicator 1020a may indicate that ‘Topic 1’ is a favorite, while the unfilled rectangles in the registered favorite indicators 1020b and 1020c may indicate ‘Topic 2’ and ‘Topic 3’ are not favorites. Activation of a registered favorite indicator may toggle the status of a registered favorite indicator. The registered acceptance indicators 1025a-1025c may be used to indicate that request associated with a topic will be accepted. For example the filled rectangle in the registered acceptance indicator 1025b may indicate that requests associated with ‘Topic 2’ will be accepted. The registered blocking indicators 1030a-1030c may be used to indicate that requests associated with a topic are to be blocked. For example, the filled rectangle in the registered blockade indicator 1030c may indicate that requests associated with ‘Topic 3’ are to be blocked. A user may be able to sort topics in the registered topic area 1005 based on whether a topic is a favorite, accepted, or blocked. A search facility may be provided for a user to locate a registered topic. A user may navigate through content of the registered topic area 1005 using typical navigation features well known in the art such as sliders, swiping, etc.

The suggested topic area 1040 may include information of topics which are recommended for a responder. The suggested topic type indicators 1035a-1035c may be used to select a type associated with a suggested topic. Activation of the ‘Fun’ suggested topic indicator 1035a may cause information of suggested topics associated with opinion or subjective type queries to be provided. Activation of the ‘Fact’ suggested topic indicator 1035b may cause information of topics associated with objective queries to be provided. The ‘Fun’ suggested topic type indicator 1035a is active as indicated by the underline in FIG. 10. The suggested topic indicators 1045a-1045c may be used to indicate information regarding a suggested topic. For example, the ‘Topic 4’ suggested topic indicator 1045a may be used to indicate a type of registration recommended to a responder for ‘Topic 4’. The suggested favorite indicators 1050a-1050c may be used to indicate that a topic is suggested as a favorite as indicated by for example the ‘X’ in the ‘Topic 4’ suggested topic indicator 1050a. A responder may accept a suggestion by activating a suitable suggested topic indicator, which may cause a suggested topic indicator to be indicated by a filled rectangle. A responder may reject a suggestion by activating a suitable suggested topic indicator which may cause a suggested topic indicator to be indicated by an empty rectangle. The suggested acceptance indicators 1055a-1055c may be used to indicate a suggestion that requests associated with a topic will be accepted by a responder. For example the ‘X’ in the suggested topic acceptance indicator 1055b may indicate that requests associated with ‘Topic 5’ are recommended to be accepted. The suggested blocking indicators 1060a-1060c may be used to indicate that requests associated with a topic are recommended to be blocked. For example, the ‘X’ in the registered blockade indicator 1060c may indicate that requests associated with ‘Topic 6’ are recommended to be blocked. A user may be able to sort topics in the suggested topic area 1040 based on whether a topic is recommended as a favorite, accepted, or blocked. A search facility may be provided for a user to locate a suggested topic. Suggested topics may be presented in an order based on ranking of suggested topics. A user may navigate through content of the suggested topic area 1040 using typical navigation features as are well known in the art such as sliders, swiping, etc. The action controls 1065a-1065b may be used to take actions regarding information indicated in the GUI 1000. The ‘Cancel’ action control 1065a may be used to exit the GUI 1000 without saving changes made in the GUI 1000. The ‘Save’ action control 1065b may be used to save information indicated in the GUI 1000.

As illustrated in FIG. 11 an exemplary query selection GUI 1100 is provided. The GUI 1100 may be provided to a user, a responder, a guide, etc. The GUI 1100 may be presented using a system such as the user system 115 (FIG. 1). The GUI 1100 may be used to obtain information of a query. The GUI 1100 may include selection indicators 1105a-1105c, query indicators 1115a-1115d, user indicators 1110a-1110d, conversation indicators 1120a-1120d, acceptance indicators 1130a-1130d, decline indicators 1135a-1135d, defer indicators 1140a-1140d, off topic indicators 1145a-1145d, and abuse indicators 1150a-1150d.

As illustrated in FIG. 11, the topic indicators 1105a-1105c may include a category, type, etc. which may be used to select a query. The topic indicators 1105a, 1105b may indicate that questions regarding ‘Astronomy’ and ‘Cosmology’ are desired. The selection indicator 1105c may indicate that queries classified as ‘Fact’ are to be provided. The user indicators 1110a-1110d may indicate information of a user associated with a request. For example, the user indicator 1110b shows that ‘Ewser’ has submitted the query ‘Is there a black hole in the middle of the Milky Way galaxy?’ as indicated in the query indicator 1115b. As illustrated in FIG. 11, the conversation indicators 1120a, 1120c, 1120d may indicate that a user associated with a request is available for a two-way communication. For example, the conversation indicator 1120a may indicate that ‘Uzer’ is available for a real-time exchange of information as indicated by the clear speech bubbles in the conversation indicator 1120a. Likewise the absence of a conversation indicator associated with the query indicator 1115b may indicate that communication with a user associated with a query does not accept two-way communications. Similarly, the filled conversation indicator 1120c may indicate that a user associated with a query is not currently accepting two-way communication. Any suitable indicator such as color, shading, etc. may be used to indicate status of the conversation indicators 1120a, 1120c, and 1120d.

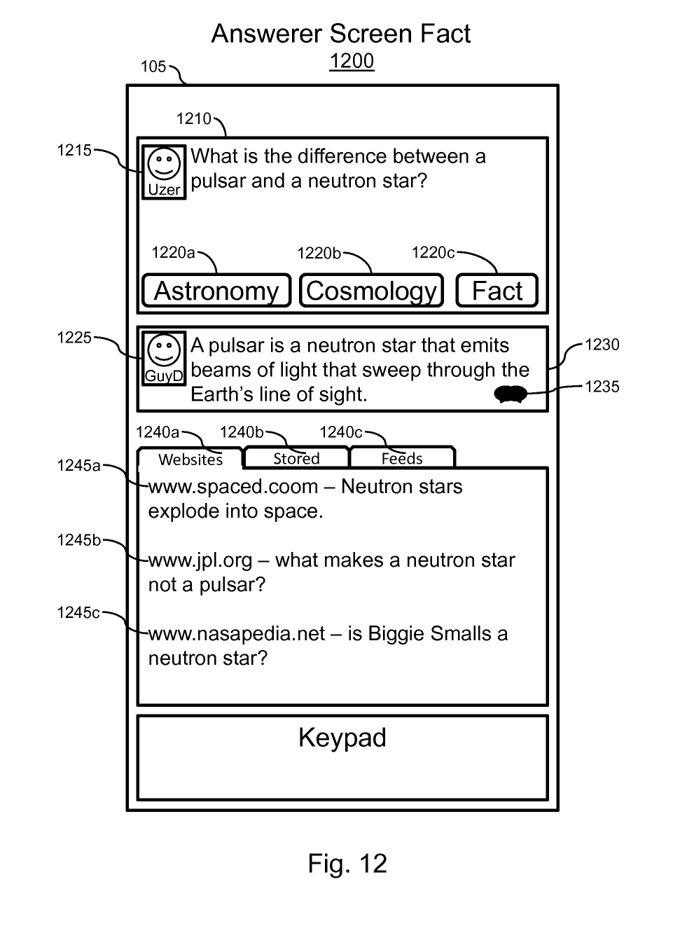

The acceptance indicators 1130a-1130d may be used to indicate that a responder accepts to respond to a request. Activation of the acceptance indicator 1130a may cause a GUI such as the GUI 1200 depicted in FIG. 12 to be provided. Activation of an acceptance indicator may cause a ranking of a topic associated with an accepted query to be increased for a responder. The decline indicators 1135a-1135d may be used to indicate that a responder declines to answer a request. Activation of the decline indicator 1135b may cause the query indicator 1115b to be closed and replaced by a different query indicator. The defer indicators 1140a-1140c may be used to indicate that a responder defers to respond to a request. If a responder activates the defer indicator 1140c, the query indicated in the query indicator 1115c may be replaced, but may be offered to the responder at a later time. The off topic indicators 1145a-1145d may be used to indicate that a query is incorrectly associated with a topic. For example, activation of the off topic indicator 1145d may cause the query indicated by the query indicator 1115d to be ranked lower for the topics ‘Astronomy’, ‘Cosmology’ and ‘Fact’, and may cause the query indicator 1115d to be replaced by another query indicator. The abuse indicators 1150a-1150d may be used to indicate that a request is inappropriate or offensive. Activation of the abuse indicator 1150c may cause a ranking or rating of a user indicated in the user indicator 1110c to be affected, and may cause the query indicator 1115c to be replaced by another query indicator.

An exemplary GUI 1200 for responding to a factual query is illustrated in FIG. 12. The GUI 1200 may be provided to a responder when a responder elects to respond to a factual request. The GUI 1200 may be provided using a device such as the user system 105 (FIG. 1). The GUI 1200 may include a query indicator 1210, a user indicator 1215, query category indicators 1220a-1220c, a responder indicator 1225, a response indicator 1230, a conversation indicator 1235, response type indicators 1240a-1240c, and response indicators 1245a-1245c.

The query indicator 1210 may be used to indicate information of a query to which a responder has chosen to respond. The user indicator 1215 may be used to indicate information of a user associated with a request. The category indicators 1220a-1220c may be used to indicate information associated with a request, which may be used to select requests. The responder indicator 1225 may be used to indicate information of a responder associated with a response indicated in the response indicator 1230. The conversation indicator 1235 may be used to indicate whether a responder indicated in the responder indicator 1225 is accepting messages. Activation of the conversation indicator 1235 may cause a communication session to be established with a responder. The response type indicators 1240a-1240c may be used to indicate a type of response which has been obtained associated with the indicator. For example, the response type indicator 1240a may provide snippets obtained from websites based on any or all elements of a request when activated. The response type indicator 1240b may provide responses associated with stored responses to previous requests which are selected based on any or all elements of a request when activated. The response type indicator 1240c may provide results obtained from RSS feeds, data providers, etc. when activated. The response indicators 1245a-1245c may be used to provide information of responses which may be appropriate. For example, the response indicator 1245b may provide details of a response when activated. While the user interfaces described herein have been illustrated using particular types and numbers of interface elements, no limitation is implied thereby, Any number and type of user interface elements as are well known in the art may be used to implement the functionalities described without departing from the scope and spirit of the embodiments described herein.

Using the methods and systems described herein topics are ranked. Topics may be determined based on analysis of a corpus of media. Content such as web pages, images, structured, data, etc. may be analyzed to determine a corpus of topics. Topics may be extracted based on processing of a group or set of requests. A ranking of topics may be determined based on the group of requests. Correlation of topics may be determined. Topics may be added to an existing list of topics based on analysis of requests. A ranking may be performed to determine a priority for offering topics to responders. Priority maybe given to topics which have high frequency of occurrence. Priority may be given to topics which have a low response rate. A ranking of all available topics may be produced, which may be used to select topics which are to be offered to a responder.

A responder may be offered topics based on a ranking of topics for the responder. A profile of a responder may be used to adjust a ranking of topics for the provider. Current topics associated with a responder may be used to modify a ranking of topics for a provider. A number of responders and a response frequency for a topic may be used to adjust a ranking of a topic for a responder. A frequency of queries associated with a responder may be used to determine or adjust a ranking or probability that a topic will be offered to a responder.

A topic may be associated with a responder based on actions of a responder. If a responder registers a topic as a favorite, or acceptable, blocks a topic, accepts a request, declines a request, etc. such actions may be used to determine whether a responder accepts a topic. If a responder accepts a query associated with a topic the topic maybe assigned to the responder. If a responder rejects a query associated with topic, a topic association with a responder may be reduced. If a responder defers, or declines a query, a topic associated with the query may be less strongly linked to a responder. If a responder indicates that a request is off topic a ranking of elements of the request for the topic may be reduced. If a responder identifies a request as abusive, a ranking of a topic based on actions of a source of the request or query may be affected.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. Further, according to an aspect of the embodiments, any combinations of the described features, functions and/or operations can be provided.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A method comprising:
receiving a request;
assigning a topic to the request;
presenting the request to a responder; and
assigning topics to the responder based on an action of the responder responsive to the request.

2. The method of claim 1 further comprising:
defining the topics based on frequency of occurrence of the topics in a corpus of requests and responses.

3. The method of claim 1 further comprising:
establishing a weighting of the topics for the topic based on correlation of the topics to the topic in a corpus of queries and answers; and
increasing a probability that the topic will be assigned to the responder when the topics are strongly correlated to the topic.

4. The method of claim 1 further comprising:
increasing a probability that the topics will be assigned to the responder when a pre-determined number of responders are not assigned to the topic.

5. The method of claim 1 further comprising:
increasing a probability that the topics will be assigned to the responder when the topics have a temporally increasing usage in a corpus of queries and answers.

6. The method of claim 1 further comprising:
increasing a probability that the topics will be assigned to the responder when the topics occur more frequently in a corpus of requests and responses selected based on a profile of a source of the request.

7. The method of claim 1 further comprising:
selecting the topics based on media associated with responses to requests associated with the topic; and
adding a phrase to the topics when a response indicates the phrase and the phrase is not found in the topics.

8. The method of claim 1 further comprising:
ranking the topics based on the topic and reducing a ranking of the topics for a responder when the responder declines to respond to the request.

9. The method of claim 1 further comprising:
obtaining a group of the topics associated with the responder;
ranking the topic based on the group of the topics associated with the responder; and
presenting the request to the responder based on the ranking.

10. The method of claim 9 further comprising:
obtaining a profile of the responder comprising demographic and geographic information; and
modifying the ranking of the topic based on the profile of the responder.

11. The method of claim 10 further comprising:
modifying a sorting of the topics based on the profile of the responder; and
assigning the topics to the responder based on the sorting.

12. The method of claim 1 further comprising:
ranking the topic based on a number of responders associated with the topic; and
presenting the request to the responder based on the ranking and a quantity of the topics positively correlated to the topic.

13. The method of claim 1 further comprising:
reducing the ranking of the topic for the request and presenting a query associated when the action indicates that the request is not related to the topic.

14. A system, comprising:
a search system receiving a request, assigning a topic to the request, presenting the request to a responder, and assigning topics to the responder based on an action of the responder responsive to the request.

15. The system of claim 14, comprising:
a resource system providing media comprising the topic and the topics; and
providing a phrase correlated to the topic to the search system when the request is seeking subjective information.

16. A persistent computer readable medium storing therein a program for causing a computer to execute an operation including creating media content, comprising:
receiving a request;
assigning a topic to the request;
presenting the request to a responder; and
assigning topics to the responder based on an action of the responder responsive to the request.

17. The computer readable storage medium of claim 16 wherein the operation further comprises:
defining the topics based on frequency of occurrence of the topics in a corpus of requests and responses;
establishing a weighting of the topics for the topic based on correlation of the topics to the topic in a corpus of queries and answers;
increasing a probability that the topic will be assigned to the responder when the topics are strongly correlated to the topic; and
increasing the probability that the topics will be assigned to the responder when a pre-determined number of responders are not assigned to the topic.

18. The computer readable storage medium of claim 16 wherein the operation further comprises:
assigning the topics to the provider based on a quantity of responders assigned to the topics and an amount of time for which a responder assigned to the topic is available.

19. The computer readable storage medium of claim 16 wherein the operation further comprises:
increasing a probability that the topics will be assigned to the responder when the request is seeking subjective information; and
selecting the responder for requests based on a ranking of the responder for the topics when the requests are seeking subjective information.

20. The computer readable storage medium of claim 16 wherein the operation further comprises:
decreasing a probability that the topics will be assigned to the responder when the request is seeking objective information; and
selecting the responder for requests based on a ranking of the responder for the topics when the requests are seeking objective information.
